(19) United States
(12) Patent Application Publication
(10) Pub. No.: US 2010/0239974 A1
(43) Pub. Date: Sep. 23, 2010

(54) TONER AND METHOD OF MANUFACTURING TONER

(76) Inventors: Tsuyoshi Nozaki, Ikeda-shi (JP); Takuya Kadota, Kobe-shi (JP); Tomohiro Fukao, Minoo-shi (JP); Tomoharu Miki, Ikeda-shi (JP); Yoshihiro Mikuriya, Nishinomiya-shi (JP); Atsushi Yamamoto, Kawanishi-shi (JP); Yoshimichi Ishikawa, Itami-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/725,094

(22) Filed: Mar. 16, 2010

(30) Foreign Application Priority Data
Mar. 17, 2009 (JP) 2009-064469
Feb. 2, 2010 (JP) 2010-021049

(51) Int. Cl. G03G 9/08; G03G 13/20; G03G 5/00

(52) U.S. Cl. 430/110.2; 430/124.1; 430/137.1

(57) ABSTRACT

A toner containing a mother toner particle containing at least two kinds of resins having a polyester skeleton, and a coloring agent, and a releasing agent, wherein the mother toner particle has a core and a shell layer thereon, and no peak that derives from magnesium, calcium, or aluminum in the mother toner particle is observed in a qualitative analysis using an X-ray fluorescence measuring instrument.

### BACKGROUND OF THE INVENTION

1. Field of the Invention

The present invention relates to toner, and a method of manufacturing the toner.

2. Discussion of the Background

Original and innovative researches and development have been made for electrophotography with various kinds of technical approaches.

In the electrophotography, an image is formed by developing a latent electrostatic image prepared by charging and irradiating the surface of an image bearing member with a colored toner to obtain a toner image, transferring the toner image to a transfer medium such as transfer paper, and fixing the toner image thereon with a heating roller, etc.

A contact heating fixing system such as a heating roller fixing system is widely employed as the fixing system for toner. The fixing device for use in the heating roller fixing system includes a heating roller and a pressure roller. In this fixing system, the toner image is fixed on the recording sheet by melting when a recording sheet bearing the toner image passes through a contact pressure (nip) portion of the heating roller and the pressure roller.

A vinyl based polymeric resin and a resin having a polyester skeleton are typical examples of the resin for use in the toner. These resins have advantages and disadvantages respectively with regard to the toner functions and characteristics such as fluidity, mobility, chargeability, fixability and image characteristics. Therefore, a mixture of both resins and/or a hybrid resin having both skeletons have been widely used in recent years. In addition to the typical mixing, kneading and pulverization method as the toner manufacturing method, there are wet granulation methods also referred to as chemical toner methods such as a suspension method or emulsification method in which an organic solvent and an aqueous medium are used, a suspension polymerization method in which toner particles are directly obtained by controlling and polymerizing polymerizable monomer droplets, and an agglomeration method in which toner particles are agglomerated by preparing emulsified particulates.

For example, unexamined published Japanese patent application No. (hereinafter referred to as JOP) 2005-084183 describes a toner having a structure of a core containing a polyester resin and a cover layer containing a vinyl based resin. The cover layer is formed of resin particulates prepared by an emulsification polymerization method using a surface active agent or an emulsification dispersion method using a surface active agent and on the surface of a colored resin particle manufactured by an emulsification dispersion method. JOP 2004-295105 describes a toner prepared by a process in which resin particles are agglomerated in an aqueous medium. To be specific, a liquid dispersion is prepared by dispersing a resin solution formed by dissolving a polyester resin and a styrene acryl based resin in an organic solvent in an organic solvent. Thereafter, the organic solvent is removed from the liquid dispersion followed by agglomeration of resin particles in an aqueous medium.

JOPs 2008-056915 and 2008-268353 describe a method of manufacturing a toner having a mother toner particle covered with resin particulates. The toner is prepared by mixing an organic solvent phase in an aqueous medium in which the resin particulates of a vinyl based resin, a polyurethane resin, an epoxy resin, a polyester resin or any combination thereof are dispersed in advance in a dissolution suspension method for preparing a mother toner particle.

However, the toner prepared by the method is difficult to have a smooth and even cover layer on the surface of the toner because the particulates are unevenly attached to the surface of the toner in the granulation or shelling process under the condition of high shearing which is indispensable to a dissolution suspension method.

In addition, JOP 2004-271686 describes a toner prepared by obtaining resin particulates having a particle size of 1 μm from a polyester based resin and carnauba wax in polyaddition reaction or polycondensation reaction, dispersing the resin particulates in an aqueous medium to prepare a liquid dispersion, and salt-outing/adhering the resin particulates in the liquid dispersion in the aqueous medium. Japanese patent No. 3577390 describes a toner obtained by preparing resin particulates having a particle size of 0.9 μm from a polyester based resin and an oxidized polypropylene followed by agglomeration. In addition, JOP H11-007156 describes a toner prepared by forming and agglomerating resin particulates having a size of from 0.4 to 0.7 μm from a polyester based resin and paraffin wax by using suspension granulation performed by introducing into an aqueous medium a liquid mixture prepared by dissolving or dispersing toner material containing a binder resin formed of multiple polyester resins having different acid values or glass transition temperatures and a coloring agent in an organic solvent.

In the contact heating fixing system described above, a low heating temperature means saving energy. Therefore, a resin in a toner preferably has a low melting point. However, a mechanical stress or a thermal stress is applied to a toner in the electrophotography process, which invites limitation on thermal characteristics of the toner such as glass transition temperature to avoid blocking, or on molecular weight of the toner to prevent cracking. The resin contained in the toner is preferable to satisfy these characteristics.

These two are in a trade-off relationship and balancing these two is preferable.

To provide this balance, a core/shell type toner is manufactured and known. Such a toner contains a resin favorable in terms of heat fixing in the core and a resin favorable in terms of blocking in the shell that covers the core.

In addition, as a material for such a resin, polyester is well known because of its advantages for toughness, heat resistance, and fixability. For example, Japanese patent No. 4033096 describes a technology in which a core particle is manufactured by agglomeration and/or curing salting of a liquid dispersion of polyester resin particulates using an agglomeration salt and a liquid dispersion of polyester resin particulates is added to form a shell layer by agglomeration/curing salting using an agglomeration salt followed by adhesion of the core particle and the shell layer. Furthermore, JOP 2008-089670 describes a method in which both a core and a shell layer are formed by dissolving a polyester resin in an organic solvent and preparing resin particulates by a phase transfer emulsification followed by addition of an electrolyte for agglomeration.

However, the toners manufactured by using such an agglomeration salt or an electrolyte are unstable in the environment change in general. In addition, when a shell layer is formed by agglomeration of particulates, the shell layer tends not to cover the core evenly or adhesion between the shell particulates tends to be insufficient, which causes a problem of bleeding of a releasing agent.

In addition, the obtained toner is generally not smooth, thereby causing a problem on uniformity of chargeability. In the case of adhesion accelerated by heating, the structure materials are easily re-arranged, which leads to a problem of non-uniform covering by the shell layer.

Because of these reasons, the present inventors recognize that a need exists for a toner having a good balance between the fixing property and the heat resistance, a good uniformity on chargeability and a good environment stability.

Accordingly, an object of the present invention is to provide a toner having a good balance between the fixing property and the heat resistance, a good uniformity on chargeability and a good environment stability.

Briefly this object and other objects of the present invention as hereinafter described will become more readily apparent and can be attained, either individually or in combination thereof, by a toner including a mother toner particle containing at least two kinds of resins having a polyester skeleton, and a coloring agent, and a releasing agent, wherein the mother toner particle has a core and a shell layer thereon, and no peak that derives from magnesium, calcium, or aluminum in the mother toner particle is observed in a qualitative analysis using an X-ray fluorescence measuring instrument.

It is preferred, in the toner mentioned above, the shell layer completely covers the core and has an average thickness of from 1/160 to 1/25 based on a number average particle diameter of the toner.

It is still further preferred that, in the toner mentioned above, the average thickness of the shell layer and a glass transition temperature Tg of material of the shell layer satisfy the following relationship:

110−Ts<W<2×(155−Ts),

where Ts represents the glass transition temperature Tg (° C.) of the shell layer and W represents the average thickness (nm) of the shell.

It is still further preferred that, in the toner mentioned above, the core contains a first resin having a first polyester skeleton, and material of the shell layer comprises a second resin having a second polyester skeleton.

It is still further preferred that, in the toner mentioned above, the first resin and the second resin are incompatible with each other.

It is still further preferred that, in the toner mentioned above, the core further contains a modified polyester resin having at least one of a urethane group and a urea group.

It is still further preferred that, in the toner mentioned above, the modified polyester resin is elongated or cross-linked by reaction between a modified polyester resin having an isocyanate group at an end thereof and an amine.

As another aspect of the present invention, a development agent is provided which includes the toner mentioned above and an optional carrier.

As another aspect of the present invention, image formation method is provided which includes charging the surface of an image bearing member uniformly, writing a latent electrostatic image on the surface of the image bearing member by irradiating the surface of the image bearing member based on image data, forming a layer of a development agent containing the toner mentioned above having a thickness regulated by a layer thickness regulation member on the surface of the image bearing member, developing the latent electrostatic image with the development agent mentioned above to obtain a visualized image, transferring the visualized image on the surface of the image bearing member to a transfer medium, and fixing the visualized image on the transfer medium, and fixing the visualized image on the transfer medium.

As another aspect of the present invention, a method of manufacturing a toner is provided which includes dissolving or dispersing at least a first resin having a first polyester skeleton, a releasing agent, and a coloring agent in an organic solvent to obtain a lysate or dispersion matter, forming core particles by suspending the lysate or dispersion matter in an aqueous medium to obtain a liquid suspension in which the core particles are dispersed in the aqueous medium, preparing a liquid dispersion of particulates containing a second resin having a second polyester skeleton, forming a shell layer on the core particles by adding the liquid dispersion of particulates containing a second resin having a second polyester skeleton to the liquid suspension, and removing the organic solvent.

It is preferred that, in the step of forming a shell layer, the second resin is dissolved in an organic solvent and precipitates on the surface of the core particles to make the shell layer have a successive structure.

It is still further preferred that, the aqueous medium includes the surface active agent.

It is still further preferred that, the step of removing the organic solvent is conducted before the step of forming a shell layer.

It is still further preferred that, the particulate formed of the second resin has a volume average particle diameter of 0.2 μm or smaller.

It is still further preferred that, the step of removing the organic solvent is conducted after the step of forming a shell layer on the core particles.

It is still further preferred that, in the step of forming the shell layer, the shell layer is formed with heating the liquid suspension to the glass transition temperature Tg of the second resin at highest.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an STEM image of a cross section of the toner particle obtained in Example 2 described later;

FIG. 2 is a diagram illustrating a structure example of part of the image forming apparatus using the toner of the present invention;

FIG. 3 is a diagram illustrating a structure example of the fixing device for use in the image forming apparatus using the toner of the present invention;

FIG. 4 is a diagram illustrating another structure example of part of the image forming apparatus using the toner of the present invention;

FIG. 5 is a diagram illustrating another structure example of part of the image forming apparatus using the toner of the present invention;

FIG. 6 is a diagram illustrating an example of the process cartridge using the toner of the present invention;

FIG. 7 is a graph illustrating the measuring result of fluorescence X-ray for the mother toner particle of Example 1 described later with regard to magnesium;

FIG. 8 is a graph illustrating the measuring result of fluorescence X-ray for the mother toner particle of Comparative Example 3 described later which contains magnesium;

FIG. 9 is a graph illustrating the measuring result of fluorescence X-ray for the mother toner particle of Example 1 described later with regard to aluminum;

FIG. 10 is a graph illustrating the measuring result of fluorescence X-ray for the mother toner particle of Comparative Example 3 described later which contains aluminum;

FIG. 11 is a graph illustrating the measuring result of fluorescence X-ray for the mother toner particle of Example 1 described later with regard to calcium; and

FIG. 12 is a graph illustrating the measuring result of fluorescence X-ray for the mother toner particle of Comparative Example 3 described later which contains calcium.

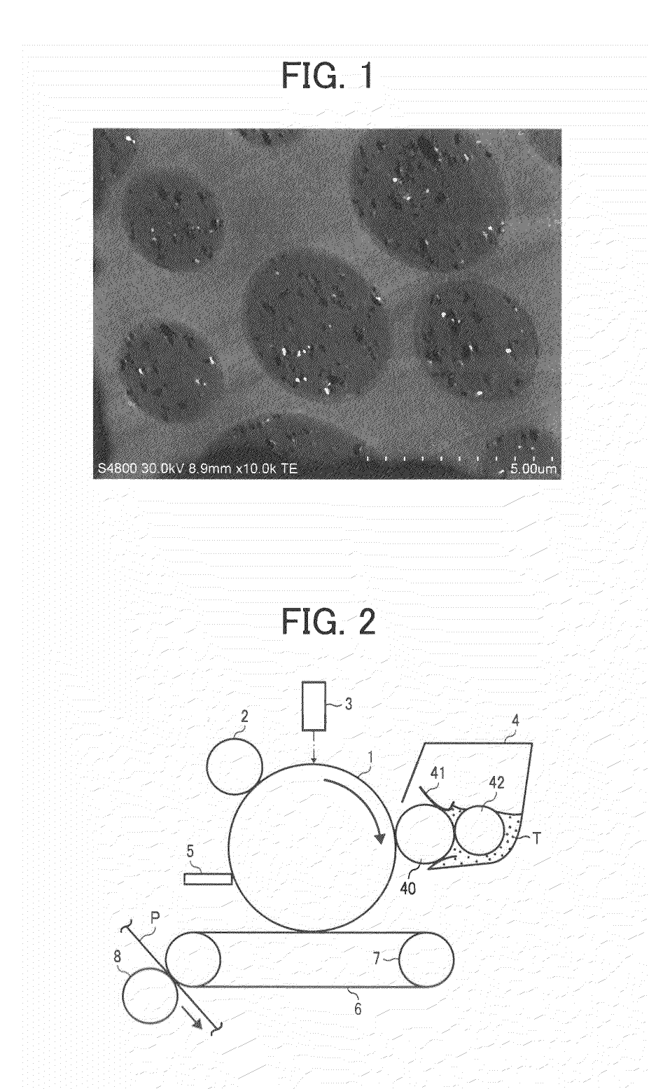

### DETAILED DESCRIPTION OF THE INVENTION

When an agglomeration salt or an electrolyte containing magnesium, calcium, and/or aluminum is used to form the core portion and the shell portion of a toner containing a resin having a polyester skeleton with a structure of a core portion and a shell portion, magnesium, calcium, and/or aluminum cannot be removed completely by washing and thus remain inside the toner, which degrade the environment stability.

According to the present invention, the toner is manufactured by using no such process. Thus, the obtained toner contains no metals deriving from an agglomeration salt which are originally unnecessary.

### Polyester Resin

Polycondensation products of the following polyols (1) and polycarboxylic acids (2) can be used as the polyester resin for use in the present invention and any combinations can be used. Also, a mixture of several kinds of polyester resins can be used.

In the present invention, the resins having a polyester skeleton but different from each other represent resins having a different polyester skeleton, and resins having a different molecular weight even with the same polyester skeleton (the same polyester skeleton means the same monomer species/ratio and the same order of placing the monomer).

### Polyol

Specific examples of the polyols (1) include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F, and bisphenol S), 4,4′-dihydroxybiphenyls such as 3,3-difluoro-4,4′-dihydroxybiphenyl; bis(hydroxyphenyl)alkanes such as bis(3-fluoro-4-hydroxyphenyl)methane, 1-phenyl-1,1′-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also referred to as tetrafluorobisphenol A), and 2,2-bis(3-hydroxyphenyl)-1,1,1,3,3,3-hexafluoropropane; bis(4-hydrorxyphenyl)ethers such as bis(3-fluoro-4-hydroxyphenyl)ether; adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having 2 to 12 carbon atoms and adducts of a bisphenol with an alkylene oxide are preferable. Adducts of bisphenol with an alkylene oxide and mixtures of an adduct of a bisphenol with an alkylene oxide and an alkylene glycol having 2 to 12 carbon atoms are particularly preferable.

Specific examples of the aliphatic polyols having three or more hydroxyl groups include, but are not limited to, glycerin, trimethylol ethane, trimethylol propane, pentaerythritol and sorbitol); polyphenols having three or more hydroxyl groups (trisphenol PA, phenol novolak and cresol novolak); and adducts of the polyphenols having three or more hydroxyl groups mentioned above with an alkylene oxide.

The polyols specified above can be used alone or in combination.

### Polycarboxylic Acid

Specific examples of the polycarboxylic acids (2) include, but are not limited to, alkylene dicarboxylic acids (e.g., succinic acid, adipic acid and sebacic acid); alkenylene dicarboxylic acids (e.g., maleic acid and fumaric acid); and aromatic dicarboxylic acids (e.g., phthalic acid, isophthalic acid, terephthalic acid, naphthalene dicarboxylic acids, 3-fluoroisophtahlic acid, 2-fluoroisophthalic acid, 2-fluoroterephtahlic acid, 2,4,5,6-tetrafluoroisophtahlic acid, 2,3,5,6-tetrafluoro terephthalic acid, 5-trifluoromethyl isophthalic acid, 2,2-bis(4-carboxyphenyl)hexafluoropropane, 2,2-bis(4-carboxyphenyl)hexafluoro propane, 2,2-bis(3-carboxyphenyl)hexafluoropropane, 2,2′-bis(trifluoromethyl)-4,4′-biphenyl dicarboxylic acid, 3,3′-bis(trifluoromethyl)4,4′-biphenyl dicarboxylic acid, 2,2′-bis(trifluoromethyl)-3,3′-biphenyl dicarboxylic acid, and hexafluoro isopropylidene diphthalic anhydride.

Among these compounds, alkenylene dicarboxylic acids having 4 to 20 carbon atoms and aromatic dicarboxylic acids having 8 to 20 carbon atoms are preferably used. Specific examples of the polycarboxylic acids having three or more hydroxyl groups include, but are not limited to, aromatic polycarboxylic acids having 9 to 20 carbon atoms (e.g., trimellitic acid and pyromellitic acid). Anhydrides or lower alkyl esters (e.g., methyl esters, ethyl esters or isopropyl esters) of the polycarboxylic acids specified above reacted with a polyol (1) can be used.

The polycarboxylic acids specified above can be used alone or in combination and are not limited to the specified above.

### Ratio of Polyol to Polycarboxylic Acid

A suitable mixing ratio (i.e., an equivalence ratio [OH]/[COOH]) of a polyol (1) to a polycarboxylic acid (2) is from 2/1 to 1/1, preferably from 1.5/1 to 1/1, and more preferably from 1.3/1 to 1.02/1.

### Molecular Weight of Polyester Resin

The peak molecular weight is from 1,000 to 30,000, preferably from 1,500 to 10,000 and more preferably from 2,000 to 8,000.

When the peak molecular weight is too small, the high temperature preservability of the toner tends to deteriorate. When the peak molecular weight is too large, the low temperature fixing property easily deteriorates.

### Modified Polyester Resin

The binder resin contained in the core particle of the toner of the present invention optionally contains a modified polyester resin with a urethane group and/or a urea group to control viscosity and elasticity in addition to the unmodified resin (first resin having a first polyester skeleton) mentioned above having a polyester skeleton.

The content ratio of the modified polyester resin having a urethane and/or urea group in the binder resin is preferably not greater than 20% by weight, more preferably not greater than 15% by weight, and furthermore preferably not greater than 10% by weight. A content ratio that is too high tends to degrade the low temperature fixing property. The modified polyester resin having an urethane and/or urea group can be directly mixed with the binder resin (A) but is preferably manufactured by mixing a modified polyester having an isocyanate group at its end and a relatively low molecular weight (hereafter referred to as prepolymer), an amine reactive therewith and the binder resin followed by elongation reaction and/or cross-linking reaction during or after granulation to obtain a modified polyester resin having an urethane and/or urea group. Thereby, the binder resin can easily contain a modified polyester resin having a relatively large molecular weight for adjustment of viscosity and elasticity.

### Prepolymer

The polyester prepolymer mentioned above can be prepared by, for example, reacting a polyester having an active hydrogen group, which is a polycondensation product of a polyol (1) and a polycarboxylic acid (2), and a polyisocyanate (3). Specific examples of the active hydrogen group contained in the polyester mentioned above including the mentioned above include, but are not limited to, hydroxyl groups (alcohol hydroxyl groups and phenol hydroxyl groups), amino groups, carboxylic groups, and mercarpto groups. Among these, alcohol hydroxyl groups are particularly preferred.

### Polyisocyanate

Specific examples of the polyisocyanates (3) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisosycantes (e.g., tolylene diisocyanate and diphenylmethane diisocyanate); aromatic aliphatic diisocyanates (e.g., α,α,α′,α′-tetramethyl xylylene diisocyanate); isocyanurates; blocked polyisocyanates in which the polyisocyanates mentioned above are blocked with phenol derivatives thereof, oximes or caprolactams; etc. These compounds can be used alone or in combination.

### Ratio of Isocyanate Group to Hydroxyl Group

Suitable mixing ratio (i.e., [NCO]/[OH]) of a polyisocyanate (PIC) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner tends to deteriorate. When the molar ratio of [NCO] is too small, the urea content of a modified polyester tends to be small and the hot offset resistance easily deteriorates. The content ratio of the constitutional component of a polyisocyanate (PIC) (3) in the polyester prepolymer (A) having a polyisocyanate group at its end portion is from 0.5 to 40% by weight, preferably from 1 to 30% by weight and more preferably from 2 to 20% by weight. When the content ratio is too low, the hot offset resistance of the toner easily deteriorates. In contrast, when the content ratio is too high, the low temperature fixability of the toner tends to deteriorate.

### Number of Isocyanate Groups in Prepolymer

The number of isocyanate groups included in the prepolymer (A) per molecule is normally not less than 1, preferably from 1.5 to 3, and more preferably from 1.8 to 2.5. When the number of isocyanate groups is too small, the molecular weight of urea-modified polyester tends to be small and the hot offset resistance easily deteriorates.

Elongation Agent and/or Cross Linking Agent

In the present invention, amines can be used as an elongation agent and/or a cross linking agent.

Specific examples of the amines (B) include, but are not limited to, diamines (B1), polyamines (B2) having three or more amino groups, amino alcohols (B3), amino mercaptans (B4), amino acids (B5), and blocked amines (B6) in which the amines (B1-B5) mentioned above are blocked. The following can be used as the diamine (B1).

Aromatic diamines (e.g., phenylene diamine, diethyltoluene diamine, 4,4-diaminodiphenyl methane, tetrafluoro-p-xylylene diamine, and tetrafluoro-p-phenylene diamine);

alicyclic diamines (e.g., 4,4-diamino-3,3-dimethyldicyclohexyl methane, diaminocyclohexane and isophoron diamine);

aliphatic diamines (e.g., ethylene diamine, tetramethylene diamine, hexamethylene diamine, dodecafluorohexylene diamine, and tetracosafluorododecylene diamine).

Specific examples of the polyamines (B2) having three or more amino groups include, but are not limited to, diethylene triamine, and triethylene tetramine.

Specific examples of the amino alcohols (B3) include, but are not limited to, ethanol amine and hydroxyethyl aniline.

Specific examples of the amino mercaptan (B4) include, but are not limited to, aminoethyl mercaptan and aminopropyl mercaptan.

Specific examples of the amino acids (B5) include, but are not limited to, amino propionic acid and amino caproic acid.

Specific examples of the blocked amines (B6) include, but are not limited to, ketimine compounds which are prepared by reacting one of the amines B1-B5 mentioned above with a ketone such as acetone, methyl ethyl ketone and methyl isobutyl ketone; oxazoline compounds, etc.

### Molecular Weight Control Agent

Furthermore, the molecular weight of the modified polyesters after the cross linking reaction and/or the elongation reaction can be controlled by using a molecular-weight control agent, if desired.

Specific examples of the molecular-weight control agent include, but are not limited to, monoamines (e.g., diethyl amine, dibutyl amine, butyl amine and lauryl amine), and blocked amines (i.e., ketimine compounds) prepared by blocking the monoamines mentioned above.

### Ratio of Amino Group to Isocyanate Group

The mixing ratio of the isocyanate group to the amines (B), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant urea-modified polyester (i) decreases, resulting in deterioration of the hot offset resistance of the resultant toner.

### Coloring Agent

Suitable coloring agents (coloring material) for use in the toner of this embodiment include known dyes and pigments. Specific examples thereof include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Faise Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone BlueFast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination. The content of the coloring agent is from 1 to 15% by weight and preferably from 3 to 12% by weight based on the toner.

### Releasing Agent

Any known releasing agent can be included in the toner of the present invention. Suitable release agents include known waxes. Specific examples of the releasing agent (wax) include, but are not limited to, polyolefin waxes such as polyethylene waxes and polypropylene waxes; long chain hydrocarbons such as paraffin wax, Fischer-Tropsch wax and SAZOL wax; waxes including a carbonyl group. Specific examples of the waxes including a carbonyl group include, but are not limited to, polyalkane acid esters such as carnauba wax, montan waxes, trimethylolpropane tribehenate, pentaerythritol tetrabehenate, pentaerythritol diacetate dibehenate, glycerin tribehenate, and 1-octadecanediol distearate; polyalkanol esters such as trimellitic acid tristearyl, and distearyl maleate; polyalkylamide such as trimellitic acid tristearylamide; dialkyl ketone such as distearyl ketone, etc. Among these, polyolefin waxes and long chain hydrocarbons are preferable in terms of the polar structure and the melt viscosity and paraffin wax and Fischer-Tropsch wax are particularly preferable

### External Additive

### Inorganic Particulate

An external additive can be added to the toner of the present invention to help improving the fluidity, developability, chargeability of the coloring agent prepared or obtained in the present invention. Inorganic particulates are suitably used as such an external additive. The inorganic particulate preferably has a primary particle diameter of from 5 nm to 2 μm, and more preferably from 5 nm to 500 nm. In addition, it is preferred that the specific surface area of such inorganic particulates measured by the BET method is from 20 to 500 m²/g. The content ratio of such inorganic particulates is preferably from 0.01 to 5% by weight and particularly preferably from 0.01 to 2% by weight based on the weight of toner, Specific examples of the inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

### Polymer Particulate

In addition, polymer particulates, such as polystyrene, methacrylate copolymers and acrylate copolymers, which are obtained by a soap-free emulsification polymerization, a suspension polymerization, or a dispersion polymerization, and polycondensation thermocuring resin particles, such as silicone, benzoguanamine and nylon, can be used.

### Surface Treatment of External Additive

The external additives such as a fluidizer can be surface-treated to improve the hydrophobic property and prevent deterioration of the fluidity characteristics and chargeability in a high humidity environment.

Preferred specific examples of surface treatment agents include, but are not limited to, silane coupling agents, silyl agents, silane coupling agents having a fluorine alkyl group, organic titanate coupling agents, aluminum-based coupling agents, silicone oil, and modified-silicone oil.

### Cleaning Property Improver

As a cleaning property improver to remove a development agent remaining on an image bearing member or a primary transfer medium after transfer, stearic acid, aliphatic metal salts, for example, zinc stearate and calcium stearate, and polymer particulates manufactured by soap-free emulsification polymerization, such as polymethyl methacrylate particulates and polystyrene particulates, can be used.

The polymer particulates preferably have a narrow particle size distribution and the weight average particle diameter thereof is preferably from 0.01 to 1 μm.

### Method of Manufacturing Toner

The method of manufacturing the toner of the present invention is described below but is not limited thereto.

The method of manufacturing the toner of the present invention includes: dissolving or dispersing at least a first resin having a first polyester skeleton, a releasing agent, and a coloring agent in an organic solvent to obtain a lysate or dispersion matter; forming core particles by suspending the lysate or dispersion matter in an aqueous medium to obtain a liquid suspension in which the core particles are dispersed (suspended) in the aqueous medium; preparing a liquid dispersion of particulates comprising a second resin having a second polyester skeleton; forming a shell layer on the core particles by adding the liquid dispersion of particulates containing a second resin having a second polyester skeleton to the liquid suspension; and removing the organic solvent.

The method is described in detail below.

### Process of Granulation of Core Particles

### Organic Solvent

A volatile organic solvent having a boiling point lower than 100° C. is preferably used for granulation in terms of removing the organic solvent later.

Specific examples the organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone and methylisobuthyl ketone. These can be used alone or in combination. Among these, ester based solvents such as methyl acetate and ethyl acetate, aromatic based solvent such as toluene and xylene, and halogenized hydrocarbons such as methylene chloride, 1,2-dichloroethane, chloroform and carbon tetrachloride are especially preferred. The polyester resin, and the coloring agent can be simultaneously dissolved or dispersed but typically dissolved or dispersed in separate occasions. The organic solvent to dissolve or disperse each of the polyester resin, the coloring agent and the fixed surface protective agent can be the same or different but using the same organic solvent is preferable considering the subsequent solvent treatment. In addition, when a solvent (simple or mixed) that suitably dissolves a polyester based resin is selected, the releasing agent preferably used in the present invention is not dissolved in the solvent because of the difference of the solubility between the polyester based resin and the releasing agent.

### Dissolution or Dispersion of Polyester Based Resin

The resin density in the solution or liquid dispersion of a polyester based resin is preferably from about 40 to about 80% by weight. A resin density that is too high tends to make dissolution or dispersion difficult and the viscosity high so that handling solution or liquid dispersion is difficult. When the resin density is too low, the amount of produced particulates tends to decrease, which means that the amount of the solvent to be removed increases. When a modified polyester resin having an isocyanate group at its end is mixed with a polyester based resin, the modified polyester resin and the polyester resin can be mixed in the same solvent or liquid dispersion or manufactured separately in different solvent or liquid dispersion. Considering the solubility and the viscosity thereof, using different solvent or liquid dispersion is preferable.

### Aqueous Medium

Suitable aqueous media for use in the present invention include water, and a mixture of water with a solvent which is mixable with water.

Specific examples of such a solvent include, but are not limited to, alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc. The amount of an aqueous medium is normally from 50 to 2,000 parts by weight and preferably from 100 to 1,000 parts by weight based on 100 parts by weight of resin particulates.

### Inorganic Dispersion Agent and Organic Resin Particulate

The lysate or dispersion material of the polyester based resin and the releasing agent mentioned above is preferably dispersed in an aqueous medium in which an inorganic dispersion agent or organic resin particulates are preliminarily dispersed to have a sharp particle size distribution and stabilize the dispersion. Specific examples of the inorganic dispersion agent include, but are not limited to, tricalcium phosphate, calcium carbonate, titanium oxide, colloidal silica and hydroxyapatite. There is no specific limit to selection of the resin that forms resin particulates as long as the resin can form a dispersion body in an aqueous medium. A dispersion body having fine spherical resin particulates is preferred. Any thermoplastic resins or thermocuring resins can be used as resin particulates. Specific examples thereof include, but are not limited to, vinyl based resins, polyurethane resins, epoxy resins, polyester resins, polyamide resins, polyimide resins, silicon based resins, phenol resins, melamine resins, urea resins, aniline resins, ionomer resins, and polycarbonate resins. These resins can be used alone or in combination. Among these, vinyl resins, polyurethane resins, epoxy resins and polyester resins and their combinational use are preferred in terms that a dispersion body having fine spherical resin particulates is easy to obtain.

### Surface Active Agent

In addition, a surface active agent is optionally used when manufacturing the resin particulates mentioned above. Specific examples of the surface active agents include, but are not limited to, anionic dispersion agents, for example, alkylbenzene sulfonic acid salts, α-olefin sulfonic acid salts, and phosphoric acid salts; cationic dispersion agents, for example, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic dispersion agents, for example, fatty acid amide derivatives, polyhydric alcohol derivatives; and ampholytic dispersion agents, for example, alanine, dodecyldi(aminoethyl)glycin, di(octylaminoethyle)glycin, and N-alkyl-N,N-dimethylammonium betaine.

An extremely small amount of a surface active agent having a fluoroalkyl group is effective for a good dispersion. Specific examples of the anionic surface active agents having a fluoroalkyl group, which are preferably used, include, but are not limited to, fluoroalkyl carboxylic acids having 2 to 10 carbon atoms and their metal salts, disodium perfluorooctane sulfonylglutamate, sodium 3-{omega-fluoroalkyl(having 6 to 11 carbon atoms)oxy}-1-alkyl(having 3 to 4 carbon atoms) sulfonate, sodium 3-{omega-fluoroalkanoyl(having 6 to 8 carbon atoms)-N-ethylamino}-1-propanesulfonate, fluoroalkyl(having 11 to 20 carbon atoms) carboxylic acids and their metal salts, perfluoroalkylcarboxylic acids and their metal salts, perfluoroalkyl (having 4 to 12 carbon atoms) sulfonate and their metal salts, perfluorooctanesulfonic acid diethanol amides, N-propyl-N-(2-hydroxyethyl)perfluorooctanesulfone amide, perfluoroalkyl(having 6 to 10 carbon atoms) sulfoneamidepropyltrimethylammonium salts, salts of perfluoroalkyl(having 6 to 10 carbon atoms)-N-ethylsulfonyl glycin, and monoperfluoroalkyl (having 6 to 16 carbon atoms) ethylphosphates.

Specific examples of the cationic surface active agents having a fluoroalkyl group include, but are not limited to, primary and secondary aliphatic amino acids, secondary amino acids, aliphatic quaternary ammonium salts (for example, perfluoroalkyl(C6-C10)sulfoneamidepropyltrimethyl ammonium salts), benzalkonium salts, benzetonium chloride, pyridinium salts, and imidazolinium salts.

### Protection Colloid

Liquid droplet dispersion can be stabilized in an aqueous medium by using a polymer protection colloid. For example, the following can be used: acids such as acrylic acid, methacrylic acid, α-cyanoacrylic acid, α-cyanomethacrylic acid, itaconic acid, crotonic acid, fumaric acid, maleic acid and maleic anhydride; (meth) acrylic monomer having a hydroxyl group such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide; vinyl alcohols mentioned above or its ethers such as vinyl methyl ether, vinyl ethyl ether and vinyl propyl ether; esters of vinyl alcohol and a compound having a carboxylic group such as vinyl acetate, vinyl propionate and vinyl butyrate; amide compounds such as methylol compounds include, but are not limited to, acrylamide, methacrylamide and diacetone acrylamide and their methylol compounds; acid chlorides such as acrylic acid chloride and methacrylic acid chloride; homopolymers or copolymers having a nitrogen atom or a heterocyclic ring thereof such as vinyl pyridine, vinyl pyrrolidone, vinyl imidazole and ethylene imine; polyoxyethylenes such as polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters; and celluloses such as methyl cellulose, hydroxyethyl cellulose and hydroxypropyl cellulose. When compounds, for example, calcium phosphate, which are soluble in an acid or alkali, are used as a dispersion stabilizer, it is possible to dissolve the calcium phosphate by adding an acid, for example, hydrochloric acid, followed by washing of the resultant particles with water, to remove the calcium phosphate from the particulates. In addition, a zymolytic method can be used to remove such compounds. Such a dispersion agent may remain on the surface of toner particles. However, the dispersion agent is preferably washed and removed in terms of the charging property of toner particles.

In addition, a surface active agent containing magnesium, calcium, and/or aluminum can be used as the surface active agent or the dispersion agent. Such a surface active agent is removed by washing.

### Dispersion Method

There is no particular limit to the dispersion method. Low speed shearing methods, high speed shearing methods, friction methods, high pressure jet methods, ultrasonic methods, etc., can preferably be used.

When a high speed shearing type dispersion machine is used, there is no particular limit to the rotation speed thereof, but the rotation speed is typically from 1,000 to 30,000 rpm, and preferably from 5,000 to 20,000 rpm. The temperature during the dispersion process is from 0 to 150° C. (under pressure), and preferably from 20 to 80° C.

Elongation and/or Cross Linking Reaction

When a modified polyester resin having an isocyanate group at its end and an amine reactive therewith are added to introduce a modified polyester resin having a urethane and/or a urea linkage, the amine can be mixed in an oil phase before a toner component is dispersed in an aqueous medium or added to the aqueous medium. The reaction time is determined depending on the isocyanate group structure included in a polyester prepolymer and the reactivity thereof with the added amine and is typically from 1 minute to 40 hours and preferably from 1 to 24 hours. The reaction temperature is from 0 to 150° C. and preferably from 20 to 98° C.

### Process of Forming Shell Layer

### Liquid Dispersion of Particulate Formed of Second Resin Having Polyester Skeleton

Any known method can be used as the method of manufacturing a liquid dispersion of particulate formed of a second resin having a (second) polyester skeleton. A specific example of the known methods is that a resin is dissolved and neutralized in an organic solvent in advance, and then an aqueous medium is added for phase transfer emulsification followed by removal of the organic solvent, and another specific example is that while a mixture of a resin and an emulsification agent such as a surface active agent is sheared and stirred in an aqueous medium while heated. In addition, a liquid dispersion of polyester particulate available in the market can be suitably used. The second resin having a polyester skeleton is suitable to be attached to the surface of the core particle under the presence of an organic solvent. When the particulates are too stable under the presence of an organic solvent as the dispersion body, the particulates tend not to be attached to the core particle and thus remain as they are.

In addition, the particulates containing the second resin preferably have a volume average particle diameter of 0.3 micrometer or less and more preferably 0.2 micro meter or less. Since the particulates (e.g, 0.2 micro meter) are sufficiently small in comparison with the core particle (5 micrometer), the particulates can form a thin shell layer on the core by attaching to the surface thereof.

Particulates having a volume average particle diameter of 0.2 micrometer or greater are disadvantageous to form an extremely thin shell layer. In addition, particulates having a volume average particle diameter of 0.3 micro meter or greater easily cause agglomeration of the core particles. The (first) resin in the core portion is hardly mixed with the (second) resin in the shell portion in the method of manufacturing the toner according to the present invention and the (second) resin added to form a shell layer is present on the shell portion of the toner. A preferable core/shell structure is securely maintained by using the first resin having a polyester skeleton contained in the core portion and the second resin having a polyester skeleton contained in the shell material which is incompatible with the first resin. In addition, the first resin and the second resin separately behave to, for example, heat, which is preferable in terms of a good combination of the high temperature preservability and the fixing property.

A shell layer having an extremely even thickness is obtained by dissolving a polyester resin for use in forming a shell layer under the presence of an organic solvent once and then precipitating the polyester resin when forming the shell layer. In addition, a shell layer having an extremely even thickness is also obtained by: granulating core particles by a dissolution suspension method by high shearing in advance; adding a polyester resin for use in formation of a shell layer while gently stirring in a state in which an organic solvent is present in the core particles to dissolve the polyester resin for a shell layer once on the surface of the core particles and cover the core particles by the polyester resin; and removing the organic solvent from the core particles to precipitate the polyester resin. The thus obtained toner has an excellent even chargeability and maintains heat resistance while reducing an adverse impact on the fixing property.

The layer thickness of the shell is preferably from 1/160 to 1/25, more preferably from 1/80 to 1/30, and most particularly from 1/70 to 1/50 relative to the number average particle diameter of the toner. A releasing agent contained in a toner having a layer thickness that is too thin tends to bleed due to stress, friction heat, etc. applied to the toner, which causes a problem in the development process in particular.

To the contrary, a releasing agent contained in a toner having a layer thickness that is too thick tends to elude slowly during fixing, which causes an offset problem. In addition, a shell layer that has an uneven thickness, meaning that a shell layer having a thick portion and thin portion is formed, tends to cause the problems described above.

The average thickness W of the shell layer of the toner of the present invention and the glass transition temperature Ts of the resin in the shell layer preferably satisfy the following relationship (1):

110−Ts<W<2×(155−Ts) Relationship (1)

When the average thickness W of the shell layer is too low, the components such as the releasing agent in the toner tend to ooze due to the stress, heat, etc., which causes image contamination. To the contrary, when the average thickness W of the shell layer is too high, the releasing agent does not ooze sufficiently during fixing, or the resin in the core portion is difficult to contribute to fixing, which results in deterioration of the low temperature fixing property. In addition, the glass transition temperature Ts of the resin in the shell layer is preferably from 40 to 90 degree C., more preferably from 50 to 80 degree C., and furthermore preferably from 60 to 70 degree C. Preferably, the shell layer has a successive layer structure. Such a layer can be formed by dissolution and precipitation of the resin of the shell layer on the surface of the core particle into an organic solvent. Therefore, if the average thickness of the shell layer is reduced, image contamination hardly occurs and the fixing property is improved.

### Mixing of Aqueous Medium Containing Core Particles and Liquid Dispersion of Particulates

A shell layer containing the second resin having a polyester skeleton which covers the core particles is formed by mixing a liquid dispersion of particulates containing the second resin with an aqueous medium containing a dispersion body that become the core particles.

### Process of Removing Solvent

It is preferable to remove the organic solvent after the process of forming the shell layer containing the second resin having a polyester skeleton on the core particle by addition of the liquid dispersion of particulates containing the second resin. Any known method can be used to remove the organic solvent from the obtained emulsified dispersion body. For example, a method can be employed in which the system is gradually heated under normal pressure or with a reduced pressure to completely evaporate and remove an organic solvent in the droplets.

### Washing and Drying Process

Subsequent to removal of the organic solvent, known technologies are used in the process of washing and drying toner particles dispersed in an aqueous medium.

That is, after solid and liquid of an aqueous medium are separated by a centrifugal or a filter press to obtain a toner cake, the obtained cake is re-dispersed in de-ionized water at room temperature to about 40° C. Subsequent to optional pH adjustment by an acid or an alkali, the resultant is subject to the solid and liquid separation treatment again. This cycle is repeated several times to remove impurities and the active surface agent. Thereafter, the resultant is dried by an air stream drier, a circulation drier, a reduced pressure drier, a vibration flow drier, etc. to obtain toner powder. Toner particulate component can be removed by a centrifugal or a known classifier can be optionally used after the drying process to obtain a toner having a desired particle size distribution.

### External Addition Treatment

The thus prepared mother toner particles after the drying process can be mixed with other particles such as the charge control agent particulates and fluidizing agent particulates. Such other particles can be fixed to the toner particles by applying a mechanical impact thereto to integrate the particles into the toner particles. Thus, the other particles can be prevented from being detached from the toner particles. Specific examples of such mechanical impact application methods include, but are not limited to, methods in which a mixture is mixed by a blade rotating at a high speed and methods in which a mixture is put into a jet air to accelerate and collide the particles against each other or a collision plate. Specific examples of such mechanical impact applicators include, but are not limited to, ONG MILL (manufactured by Hosokawa Micron Co., Ltd.), modified I TYPE MILL (manufactured by Nippon Pneumatic Mfg. Co., Ltd.) in which the pressure of pulverization air is reduced, HYBRIDIZATION SYSTEM (manufactured by Nara Machine Co., Ltd.), KRYPTRON SYSTEM (manufactured by Kawasaki Heavy Industries, Ltd.), automatic mortars, etc.

### Image Formation Method, Image Foaming Apparatus and Process Cartridge Image Forming Apparatus and Process Cartridge

The image forming apparatus for use in the present invention uses the toner of the present invention to form images. The toner of the present invention can be used as a single component development agent or a two component development agent but is preferably used as a single component development agent. In addition, the image forming apparatus for use in the present invention preferably has an endless intermediate transfer device. Furthermore, the image forming apparatus for use in the present invention includes an image bearing member, and preferably a cleaning device that removes toner remaining on the image bearing member and/or the intermediate transfer device. The cleaning device optionally has a cleaning blade. In addition, the image forming apparatus for use in the present invention preferably includes a fixing device that fixes an image with a roller or belt having a heating device. In addition, the image forming apparatus for use in the present invention preferably has a fixing device that dispenses with oil application to the fixing member.

Furthermore, the image forming apparatus for use in the present invention preferably includes other suitably selected devices such as a discharging device, a recycling device, and a control device.

The image forming apparatus for use in the present invention may have a structure including a process cartridge formed of elements such as an image bearing member, a development device, and a cleaning device. The process cartridge is detachably attachable to the image forming apparatus. In addition, a process cartridge formed of an image bearing member and at least one of the devices of a charging device, an irradiation device, a development device, a transfer device, a separation device, and a cleaning device supported together with the image bearing member. The process cartridge is structured to be a single unit detachably attachable to the image forming apparatus by a guiding device such as a rail provided therein.

FIG. 2 is a diagram illustrating an example of the image forming apparatus for use in the present invention.

The image forming apparatus includes an image bearing member that is driven to rotate clockwise contained in a case (not shown), and other devices provided around the image bearing member 2 such as charging device 2, an irradiation device 3, a development device 4 accommodating the toner T of the present invention, a cleaning unit 5, an intermediate transfer body 6, a support roller 7, a transfer roller 8, and a discharging roller (not shown).

This image forming apparatus includes a paper cassette (not shown) accommodating multiple sheets of recording paper P as a recording medium. The recording paper P in the paper cassette is transferred one sheet by one sheet between the transfer roller 8 functioning as a transfer device and the intermediate transfer body 6 after adjusting the timing at a pair of registration rollers (not shown). The image forming apparatus drives the image bearing member 1 to rotate clockwise in FIG. 2; uniformly charges the image bearing member 2 with the charging device 2; then irradiates the image bearing member 1 with a laser beam modulated according to image data by the irradiation device to form a latent electrostatic image on the image bearing member 1; and attaches the toner T to the image bearing member 1 by the development device 4 to develop the latent electrostatic image. Next, the toner image on the image bearing member 1 formed by the development device 4 is transferred to the intermediate transfer body 6 by a transfer bias applied thereto and transferred to the recording paper P fed between the intermediate transfer body 6 and the transfer roller 8. Furthermore, the recording paper P on which the toner image is transferred is conveyed to the fixing device (not shown).

The fixing device includes a fixing roller that is heated to a predetermined fixing temperature by a built-in heater and a pressure roller pressed against the fixing roller with a predetermined pressure to apply heat and pressure to the recording paper P to fix the toner image thereon. Thereafter, the recording paper P is discharged to a paper discharging tray (not shown).

On the other hand, the image forming apparatus further rotates the image bearing member 1 from which the toner image is transferred to the recording paper P by the transfer roller 8 to scrape off the toner T remaining on the surface of the image bearing member 1 at the cleaning unit 5 and discharges the image bearing member 1 by the discharging device (not shown). The image forming apparatus uniformly charges the image bearing member 1 discharged by the discharging device with the charging device 2 to be ready for the next image formation.

Each member or device suitably used for the image forming apparatus for use in the present invention is fully described.

There is no specific limit to the image bearing member 1 with regard to the material, form, structure and the size thereof and any known image bearing member can be used and suitably selected. The image bearing member 1 suitably employs a drum form or a belt form. Also, an inorganic image bearing member formed of amorphous silicon or selenium or an organic image bearing member formed of polysilane, or phthalopolymethine is suitably used. Among these, amorphous silicon or an organic image photoconductor (image bearing member) is preferred in terms of long working life.

A latent electrostatic image can be formed on the image bearing member 1 by, for example, charging the surface of the image bearing member 1 followed by irradiation according to image data with a latent electrostatic image formation device. The latent electrostatic image formation device includes, for example, the charging device 2 that charges the surface of the image bearing member 1 and the irradiation device 3 that irradiates the surface of the image bearing member 1 with light according to the image data.

The charging process is performed by, for example, applying a voltage to the surface of the image bearing member 1 with the charging device 2. Any charging device can be selected as the charging device 2. For example, a known contact type charging device having an electroconductive or semi-conductive roller, brush, film, or rubber blade or a known non-contact type charging device such as corotron, or scrotron using the corona discharging are suitably used.

The charging device 2 can employ a form of a magnetic brush, or a fur brush in addition to a roller and be selected according to the specification or structure of the electrophotographic apparatus. When a magnetic brush is used, the magnet brush uses a charging member formed of, for example, ferrite particles such as Zn—Cu ferrite, a non-magnetic electroconductive sleeve that supports the charging member, and a magnet roller provided inside the sleeve. In addition, when a brush is used, material such as carbon, copper sulfate, fur electroconductively treated by metal or metal oxide, is used. The brush is formed by winding or attaching such material to metal or electroconductively treated metal core. The charging device 2 is not limited to the contact type charging device specified above but which is preferable to manufacture an image forming apparatus having a charging device producing less amount of ozone.

Irradiation is performed by, for example, irradiating the surface of the image bearing member 1 with the irradiation device 3 according to image data. Any irradiation device that can irradiate the surface of the image bearing member 1 charged by the charging device 2 according to image data is suitably used. Specific examples of such irradiation devices include, but are not limited to, various kinds of irradiation devices of a photocopying optical system, a rod lens array system, a laser optical system, or a liquid crystal shutter optical system.

Development is performed by, for example, developing a latent electrostatic image with the toner T of the present invention with the development device 4. Any known development device that can perform development with the toner of the present invention is suitably selected. For example, a development device that accommodates the toner of the present invention and includes a development unit which imparts the toner to the latent electrostatic image in a contact or non-contact manner can be suitably used.

The development device 4 preferably has a development roller 40 that rotates in contact with the image bearing member 1 while bearing toner on the circumference surface and supplies the toner to a latent electrostatic image formed on the image bearing member 1, and a thin layer formation member 41 that thin-regulates the layer of the toner on the development roller 40 while in contact with the circumference surface of the development roller 40. A metal roller or an elastic roller is suitably used as the development roller 40. Any metal roller is suitably selected and used. An example thereof is an aluminum roller. A metal roller having an arbitrary surface friction coefficient used as the development roller 40 is easily manufactured by blast treatment. To be specific, an aluminum roller subject to glass bead blast treatment to form a coarse surface to which a suitable amount of toner is attached is suitably used as the development roller 40.

A roller covered by an elastic rubber layer is further covered by a surface coating layer formed of material easily charged with a polarity reverse to that of the toner. The elastic rubber layer is set to have a hardness of 60 degree or less according to JIS-A to prevent toner deterioration caused by the concentration of pressure at the contact portion with the thin layer formation member 41. The surface roughness Ra is set to be from 0.3 to 2.0 μm to hold a suitable amount of toner on the surface. In addition, a development bias is applied between the development roller 40 and the image bearing member 1 to generate an electric field. Therefore, the elastic rubber layer is set to have a resistance of from 10³ to 10¹⁰Ω. The development roller 40 rotates clockwise and transfers the toner borne on the surface to the opposing position between the thin layer formation member 41 and the image bearing member 1.

The thin layer formation member 41 is located at a position below the contact portion of a supply roller 41 and the development roller 40. The thin layer formation 41 has a free end brought into contact with the surface of the development roller 40 by using a metal board spring formed of stainless steel (SUS), phosphorous bronze under a pressure of from 10 to 40 N/m. The toner is thin-layered and triboelectrically charged while passing through this pressure. Furthermore, a regulation bias having an offset value to the development bias in the same direction as the charging polarity of the toner is applied to the thin layer formation member 41 to assist the triboelectric charging.

Any known rubber elastic material that forms the surface of the development roller 40 can be selected and used. Specific examples thereof include, but are not limited to, styrene-butadiene based copolymer rubber, acrylonitrile-butadiene based copolymer rubber, acryl rubber, epichlorohydrine rubber, urethane rubber, silicone rubber, or blend rubber thereof. Among these, blend rubber of epichlorohydrine rubber, and acrylonitrile-butadiene based copolymer rubber is particularly preferable. The development roller 40 is manufactured by covering the outer circumference of an electroconductive shaft with rubber elastic material. The electroconductive shaft is formed by metal such as stainless steel (SUS).

The transfer is performed by a transfer roller by, for example, charging the image bearing member 1. The transfer roller preferably has a structure including a primary transfer device that transfers a toner image to the intermediate transfer body 6 to form a transfer image thereon and a secondary transfer device (transfer roller 8) that transfers the transfer image to the recording paper P. A more preferable structure of the transfer roller includes a primary transfer device that transfers an at least two color or preferably full color toner image to the intermediate transfer body 6 to form a complex transfer image and a secondary transfer device (transfer roller 8) that transfers the complex transfer image to the recording paper P. Any known transfer body is suitably selected and used as the intermediate transfer body 6. For example, a transfer belt is suitably used.

The transfer device (the primary transfer device and the secondary transfer device) preferably has a transfer unit that peels off and charges the toner image formed on the image bearing member 1 to the side of the recording paper P. Two or more transfer devices can be provided. Specific examples of the transfer device include, but are not limited to, a corona transfer device using corona discharging, a transfer belt, a transfer belt, a transfer roller, a pressure transfer roller and an adhesive transfer device. A typical example of the recording paper P is plain paper but any paper to which a non-fixed image after development is transferred can be suitably used. PET base for an overhead projector can be also used.

A toner image transferred to the recording paper P is fixed by a fixing device. Fixing can be performed every time each color toner image is transferred or at onetime for a multi-color overlapped image. Any fixing device can be suitably selected. Any known heating and pressure device can be used. A combination of a heating roller and a pressure roller and a combination of a heating roller, a pressure roller and an endless belt can be used as the heating and pressure device. The heating temperature by the heating and pressure device is preferably from 80 to 200° C.

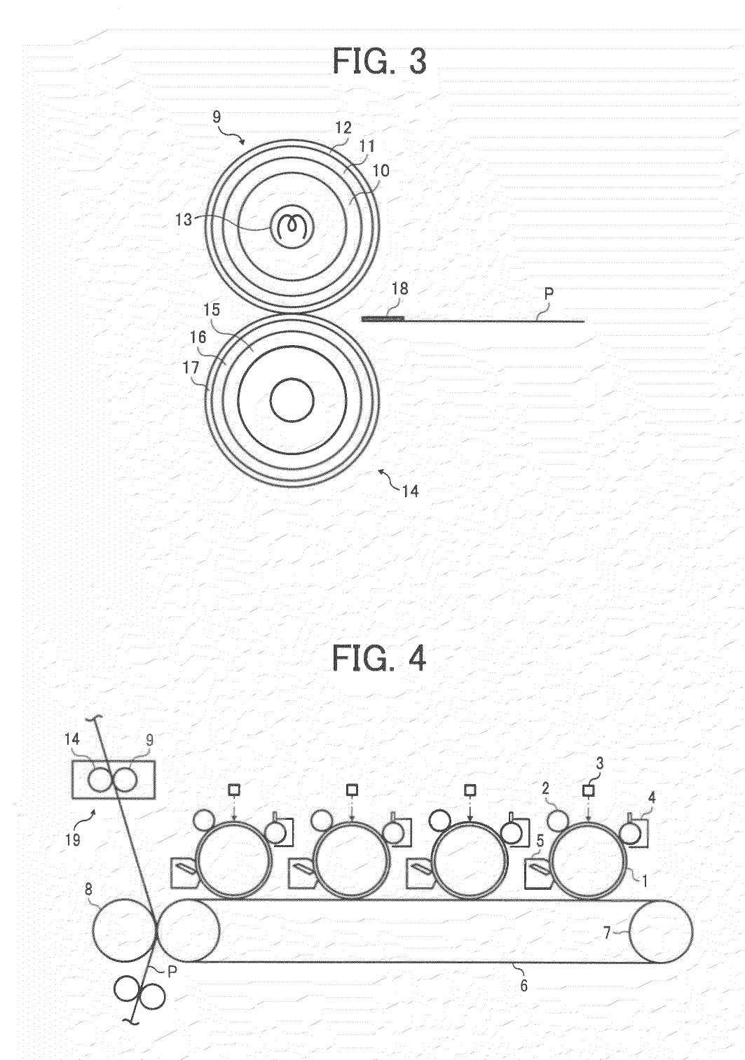

A fixing device of a soft roller type having a structure formed of fluorine based surface layer agent as illustrated in FIG. 3 can be used. This fixing device includes a heating roller 9 formed of an aluminum core 10 on which an elastic layer 11 formed of silicone rubber, and a surface layer 12 formed of PFA (copolymer of tetrafluoroethylene-perfluoroalkyl vinyl ether) are provided, and a heater 13 provided inside the aluminum core. The fixing device also includes a pressure roller 14 including an aluminum core 15 on which an elastic layer 16 formed of silicone rubber and a surface layer 17 formed of PFA are provided. The recording paper P on which a non-fixed image 18 is printed passes through the fixing device. In the present invention, an optical fixing device, etc. can be used together with or instead of the fixing device.

The image bearing member 1 is discharged by, for example, applying a discharging bias thereto by a discharging device. Any known discharging device that can apply a discharging bias to an image bearing member is suitably selected and used. For example, a discharging lamp is suitably used. The toner remaining on the surface of the image bearing member is suitably cleaned by, for example, removing the toner therefrom by a cleaning device. Any known cleaning device that can remove the toner remaining on the surface of the image bearing member can be suitably selected and used. For example, a magnetic brush cleaner, an electrostatic brush cleaner, a blade cleaner, a brush cleaner, and a web cleaner can be preferably used.

Toner can be recycled for use by, for example, transferring the toner removed by the cleaning device to the development device by a recycling device. Any known recycling device can be suitably selected and used. Each member can be suitably controlled by, for example, a control device. Any control device that can control each device or member is suitably selected and used. For example, devices such as a sequencer, and a computer can be used.

The image forming apparatus, the image formation method and the process cartridge of the present invention produce quality images by using a toner having excellent fixing property, and free from deterioration such as cracking ascribable to stress in the development process.

### Multiple Color Image Forming Apparatus

FIG. 4 is a schematic diagram illustrating an example of the multiple color image forming apparatus to which the present invention is applied. FIG. 4 is a diagram illustrating tandem type full color image forming apparatus. The image forming apparatus illustrated in FIG. 4 includes an image bearing member that is driven to rotate clockwise provided in a case (not shown), and other devices provided around the image bearing member 1 such as charging device 2, an irradiation device 3, a development device 4, an intermediate transfer body 6, a support roller 7, and a transfer roller 8. This image forming apparatus includes a paper cassette (not shown) accommodating multiple sheets of recording paper P as recording media. The recording paper P in the paper cassette is transferred one sheet by one sheet between the transfer roller 8 and the intermediate transfer body 6 after adjusting the timing at a pair of registration rollers (not shown) and fixed by a fixing device 19.

The image forming apparatus drives and rotates the image bearing member 1 clockwise in FIG. 4; uniformly charges the image bearing member 1 with the charging device 2; then irradiates the image bearing member 1 with a laser beam modulated according to image data by the irradiation device to form a latent electrostatic image on the image bearing member 1; and attaches the toner T to the image bearing member 1 by the development device 4 to develop the latent electrostatic image. The image forming apparatus transfers a toner image formed by attaching toner to the image bearing member 1 by the development device 4 to the intermediate transfer body 6. This process is performed for the four colors of yellow, magenta (M), cyan (C), and black (K) to form a full color toner image.

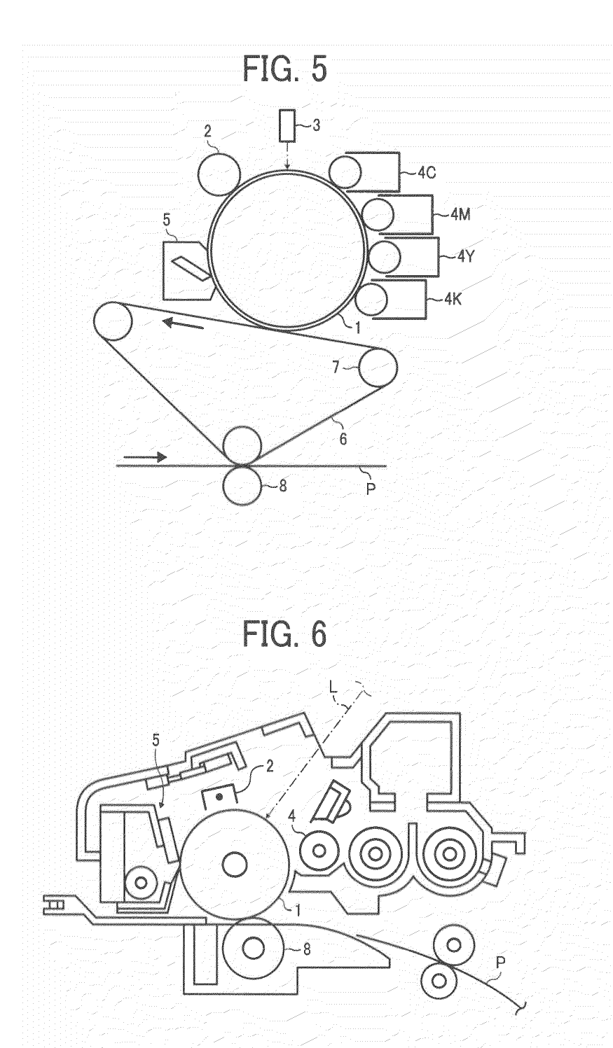

FIG. 5 is a schematic diagram illustrating an example of the full color image forming apparatus of a revolving type. This image forming apparatus sequentially develops multiple color toner images on one image bearing member by switching operation of the development device. The transfer roller 8 transfers a color toner image on the intermediate transfer body 6 to the recording paper P and conveys the recording paper P to which the color toner image is transferred to obtain a fixed image. On the other hand, the image forming apparatus further rotates the image bearing member 1 from which the toner image is transferred to the recording paper P by the intermediate transfer body 6 to scrape off the toner remaining on the surface of the image bearing member 1 at the cleaning unit 5, and discharges the image bearing member 1 by the discharging device (not shown). The image forming apparatus uniformly charges the image bearing member 1 discharged by the discharging device with the charging device 2 to be ready for the next image formation. The cleaning unit 5 is not limited to a device that scrapes off the residual toner on the image bearing member with a blade. For, example, a fur brush that scrapes off the residual toner on the image bearing member can be suitably used. The image forming apparatus and the image formation method of the present invention use the toner of the present invention as the development agent and thus produce quality images.

### Process Cartridge

The process cartridge of the present invention is detachably attachable to an image forming apparatus and includes an image bearing member that bears a latent electrostatic image, a development device that develops the latent electrostatic image borne on the image bearing member with the toner of the present invention to obtain a visualized image and other optional devices such as a charging device, a transfer device, a cleaning device, and a discharging device. The development device includes a development agent container accommodating the toner or a development agent containing the toner, a development agent bearing member that bears and transfers the toner or the development agent accommodated in the development agent container and other optional devices such as a layer thickness regulation member that regulates the layer thickness of the toner borne on the development agent bearing member. The process cartridge of the present invention is detachably attachable to various kinds of electrophotographic apparatuses, facsimile machines, printers and preferably the image forming apparatus of the present invention.

The process cartridge includes, for example, the image bearing member 1, the charging device 2, the development agent 4, the transfer roller 8, the cleaning unit 5, and other optional devices as illustrated in FIG. 6. In FIG. 6, L represents a beam from an irradiation device and P represents recording paper. Any image bearing member similar to that in the image forming apparatus described above can be used as the image bearing member 1. Any charging member can be used as the charging device 2. Next, the image formation process by the process cartridge illustrated in FIG. 6 is described. The image bearing member 1 is charged by the charging device 2, and irradiated with a beam L by an irradiation device (not shown) while rotating in the direction indicated by an arrow to form a latent electrostatic image corresponding to the irradiation image on the surface of the image bearing member 1. This latent electrostatic image is developed with toner by the development device 4 and the obtained toner image is transferred by the transfer roller 8 to the recording paper P and printed out. The surface of the image bearing member 1 after image transfer is cleaned by the cleaning unit 5 and discharged by a discharging device (not shown) to be ready for the next image formation process.

Having generally described (preferred embodiments of) this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

First, the analysis method and evaluation method about the toner obtained in Examples and Comparative Examples are described.

The toner of the present invention used as a single component development agent is evaluated. However, the toner of the present invention can be used as a two component development agent by using the toner together with a suitable carrier by suitable external treatment.

### Measuring Method

### Particle Diameter

The method of measuring the particle size distribution of the toner particles is described next.

The particle size distribution of the toner particles can be measured by Coulter Counter method, etc. For example, Coulter Counter TA-II and Coulter Multisizer II (both are manufactured by Beckman Coulter, Inc.) can be used as the measuring instrument. The measuring method is as follows.

First, add 0.1 to 5 ml of a surface active agent (preferably alkyl benzene sulfonate salt) as a dispersant to 100 to 150 ml of an electrolytic aqueous solution, which is about 1% NaCl aqueous solution prepared by using primary NaCl and pure water, for example, ISOTON-II (manufactured by Beckman Coulter, Inc.) can be used; Add 2 to 20 mg of a measuring sample of solidified toner to the electrolytic aqueous solution; Conduct dispersion treatment for the electrolytic aqueous solution in which the measuring sample is dispersed for about 1 to 3 minutes by an ultrasonic dispersion device; Measure the volume and the number of the toner particles or the toner by the equipment mentioned above with an aperture of 100 μm; and calculate the volume distribution and the number distribution. The weight average particle diameter (Dv) and the number average particle diameter (Dp) of the toner can be obtained based on the obtained distributions.

The whole range is a particle diameter of from 2.00 to less than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to less than 40.30 μm.

### Average Circularity

An optical detection method can be used for measuring particle forms in which particle images are optically detected and analyzed by a charge coupled device (CCD) camera while a suspension containing particles passes through an imaging detective portion having a plate form. The average circularity of the particle is obtained by dividing the circumferential length of the circle having the area equal to a projected toner area with the circumferential length of the projected toner area.

This value is a value measured by a flow type particle image analyzer FPIA-2100 as the average circularity. The specific procedure for obtaining the average circularity is as follows: (1) A surface active agent serving as a dispersion agent, preferably 0.1 to 0.5 ml of an alkylbenzenesulfonic acid salt, is added to 100 to 150 ml of water from which solid impurities have been preliminarily removed; (2) About 0.1 to about 0.5 g of a sample to be measured is added into the mixture prepared in (1); The prepared mixture in (2) is subjected to an ultrasonic dispersion treatment for about 1 to about 3 minutes such that the concentration of the particles is 3,000 to 10,000 particles per micro litter; and the form and average particle diameter distribution of the sample are measured by the instrument mentioned above.

### Volume Average Particle Diameter of Resin Particulate

The volume average particle diameter of resin particulates can be measured by a nano track particle size distribution measuring device (UPA-EX150, manufactured by Nikkiso Co., Ltd.) based on a dynamic light scattering method or a laser Doppler method. To be specific, a liquid dispersion in which resin particulates are dispersed is adjusted to be in the measuring density range before measurement. At the same time, just the solvent of the liquid dispersion is measured for background measurement. The range of from several tens nm to several μm, which is the volume average particle diameter of the resin particulates for use in the present invention, is measurable according to this measuring method.

### Molecular Weight

The molecular weight of the polyester resin or the vinyl based copolymer resins for use in the present invention is measured by a typical gel permeation chromatography under the following conditions:

Instrument: HLC-8220 GPC (manufactured by Tosoh Corporation)

Column: TSK gel Super HZM-M 3

Temperature: 40 degree C.

Solvent: tetrahydrofuran (THF)

Flow speed: 0.35 ml/minute

Sample: Density: Inject 0.01 ml of sample having a density of from 0.05 to 0.6%

The weight average molecular weight Mw is calculated by using the molecular weight calibration curve made based on a simple dispersion polystyrene standard sample from the molecular weight distribution of the toner resin measured under the conditions specified above. The simple dispersion polystyrene standard samples are the following ten samples: 5.8×100, 1.085×10,000, 5.95×10,000, 3.2×100,000, 2.56×1,000,000, 2.93×1,000, 2.85×10,000, 1.48×100,000, 8.417×100,000 and 7.5×1,000,000.

### Glass Transition Temperature and Endothermic Amount

The glass transition temperature (Tg) of the polyester resin and the vinyl based copolymer resin can be measured by using, for example, a differential scanning calorimeter (e.g., DSC-6220R, manufactured by Seiko Instruments Inc.) in the following manner: Heat a sample from room temperature to 150° C. at a temperature rise speed of 10° C./min; Leave the sample at 150° C. for 10 minutes; Cool down the sample to the room temperature at a temperature decline speed of 10° C./min; Leave the sample at the room temperature for 10 minutes: Heat the sample again to 150° C. at a temperature rise speed of 10° C./min; and obtain the glass transition temperature from the base line equal to or lower than the glass transition temperature and the curve corresponding to the height of the base line equal to or higher than the glass transition temperature corresponding to ½.

In addition, the endothermic amount of the releasing agent, etc, can be measured in the same manner. The endothermic amount is obtained by calculating the peak area of the measured endothermic peak. In general, a releasing agent existent inside the toner is melted at a temperature lower than the fixing temperature and the melting heat at the time demonstrates the endothermic peak. In addition, some releasing agents have phase transition heat by the phase transition at the solid phase in addition to the melting heat. In the present invention, the total of both heats is defined as the endothermic amount of the melting heat.

### Intensity of Fluorescence X-Ray

The peak intensity of Mg, Ca, or Al for characteristic X-rays Kalpha measured by fluorescence X ray measuring instrument is conducted for toner processed to have a pellet form under the following conditions:

Instrument: X-ray fluorescence spectrometer (ZSX-Primus, manufactured by Rigaku Corporation)
Detection system: Counter tube (flow type)
Tube voltage/current: 5 kV/30 mA
Scanning time: 0.2 seconds

### Measurement of Average Thickness of Shell Layer

The average thickness of a shell layer is measured as follows:

An epoxy resin of a 30 minute curing type is dropped to a stub proper for the instrument and left for 30 minutes. A sample is coated on the epoxy resin and left undone for one day and one night. Thereafter, the toner cross section is manufactured by an ultramicrotome (ultrasonic). The toner cross section is observed by a scanning type transmission electron microscope (STEM), or a Schottky field emission type scanning electron microscope (Schottky FE-SEM). The thickness of the shell layer is measured for 100 toner particles from the obtained cross section image using an image analysis type particle size distribution measuring software (Mac-View, manufactured by Mountech Co., Ltd.), in which four points (right, left, top and bottom) are measured per particle and the average thickness of the shell layer is obtained.

### Evaluation Method

### Anti-Stress Property

A predetermined printed pattern having a B/W ratio of 6% is continuously printed with an externally addition treated toner in an N/N environment (23° C. and 45%) using ipsio CX 2500 (manufactured by Ricoh Co. Ltd.) After a run length of 3,000 sheets in the N/N environment, the toner on the development roller while printing a white pattern is suctioned to measure the amount of charge by an electrometer. The difference of the amount of charge between 50 sheet printing and 3,000 sheet printing is evaluated.

E (Excellent): Absolute difference of the amount of charge is 5 μC/g or less

G (Good): Absolute value difference of the amount of charge is greater than 5 to 10 μC/g.

F (Fair): Absolute difference of the amount of charge is greater than 10 to 15 μC/g.

Bad (Bad): Absolute difference of the amount of charge is greater than 15 μC/g

### Environment Durability

A predetermined printed pattern having a B/W ratio of 6% is continuously printed with an externally addition treated toner in an N/N environment (23° C. and 45%) using ipsio CX 2500 (manufactured by Ricoh Co. Ltd.). After a run length of 50 sheets, toner on the development roller in printing white sheet pattern is sucked and the amount of charge is measured by an electrometer. Then, after a run length of 2,000 in the N/N environment (i.e., after duration), the N/N environment is changed to the H/H environment (27° C. and 80%) followed by measurement on the amount of charge by the electrometer in the same manner as described above. The difference between the amount of charge measured in the N/N environment after the 50 sheet printing in the N/N environment and that in the H/H environment after 2,000 sheet printing in the N/N environment is evaluated.

E (Excellent): Absolute difference of the amount of charge is 10 μC/g or less

F (Fair): Absolute difference of the amount of charge is greater then 10 to 15 μC/g.

Bad (Bad): Absolute difference of the amount of charge is greater than 15 μC/g

### Fixing Property

An unfixed solid image having a width of 36 mm is printed at 3 mm from the front end of an A4 sheet by ipsio CX 2500 (manufactured by Ricoh Co. Ltd.) with an externally addition treated toner (development agent) with an attachment amount of 11 g/m². This unfixed image is fixed by using the following fixing device in the temperature range of from 115 to 175° C. with a gap of 10° C. to obtain separable and non-offset temperature range. The temperature range represents the fixing temperature range in which the sheet is suitably separated from the heating roller without causing an offset phenomenon. The paper and the paper feed direction are 45 g/m² paper perpendicular to the machine direction, which are disadvantageous in terms of separability. The circumferential speed of the fixing device is set to be 200 mm/sec.

The fixing device of a soft roller type having a structure formed of fluorine based surface layer agent as illustrated in FIG. 3 is used. To be specific, this fixing device includes a heating roller 9 formed of an aluminum core having an outer diameter of 40 mm on which an elastic layer 1.5 having a thickness of 1. 5 mm formed of silicone rubber, and a surface layer 12 formed of PFA (copolymer of tetrafluoroethylene-perfluoroalkyl vinyl ether) are provided and a heater 13 provided inside the aluminum core. The fixing device also includes a pressure roller 14 including an aluminum core 15 having an outer diameter of 40 mm on which an elastic layer 1.5 having a thickness of 1.5 mm formed of silicone rubber and a surface layer 17 formed of PFA are provided. The recording paper P on which a non-fixed image 18 is printed passes through The fixing device.

E (Excellent): fixed image separable and non-offset in the range of from 115 to 175° C. and sufficiently durable.

G (Good): fixed image separable and non-offset in the range of from 115 to 175° C. but easily peeled or damaged by scraping or friction in the low temperature range.

F (fair): fixed image separable with non-offset phenomenon in the temperature range of from 30 to lower than 50° C.

B (bad): fixed image separable with non-offset phenomenon at a temperature lower than 30° C.

### High Temperature Preservability

The toner is preserved at 55° C. for 8 hours and thereafter screened with a sieve having a 42 mesh for 2 minutes and the remaining ratio of the toner on the wire screen is determined as an indicator of the high temperature preservability. The toner is evaluated and ranked into 4 levels with regard to the high temperature preservability

E (Excellent): less than 10%

G (Good): 10 to 20%

F (Fair): 20 to 30%

B (Bad): 30 or higher

Next, the preparation method of toner material for use in Examples is described. Synthesis of Polyester

### Polyester 1

The following components are placed in a reaction container equipped with a condenser, a stirrer and a nitrogen introducing tube to conduct a reaction at 230° C. at normal pressure for 8 hours followed by another reaction for 5 hours with a reduced pressure of 10 to 15 mmHg. Then, 130 parts of trimellitic anhydride is placed in the reaction container to conduct reaction at 180° C. under normal pressure to obtain [Polyester 1].

| | | |
|---|---|---|
| Adduct of bisphenol A with 2 mole of ethylene oxide | 2,765 | parts |
| Adduct of bisphenol A with 2 mole of propylene oxide: | 480 | parts |
| Terephthalic acid: | 1,100 | parts |
| Adipic acid: | 225 | parts |
| Dibutyl tin oxide: | 10 | parts |

[Polyester 1] has a number average molecular weight of 2,200, a weight average molecular weight of 5,600, a glass transition temperature of 43° C., and an acid value of 24 mgKOH/g.

### Polyester 2

The following components are placed in a reaction container equipped with a condenser, a stirrer and a nitrogen introducing tube to conduct a reaction at 230° C. at normal pressure for 8 hours followed by another reaction for 5 hours with a reduced pressure of 10 to 15 mmHg. Then, 220 parts of trimellitic anhydride is placed in the reaction container to conduct reaction at 180° C. under normal pressure to obtain [Polyester 2].

| | | |
|---|---|---|
| Adduct of bisphenol A with 2 mole of ethylene oxide | 1,195 | parts |
| Adduct of bisphenol A with 3 mole of propylene oxide: | 2,765 | parts |
| Terephthalic acid: | 900 | parts |
| Adipic acid: | 200 | parts |
| Dibutyl tin oxide: | 10 | parts |

[Polyester 2] has a number average molecular weight of 2,500, a weight average molecular weight of 6,500, a glass transition temperature of 47° C., and an acid value of 18 mgKOH/g.

### Polyester 3

The following components are placed in a reaction container equipped with a condenser, a stirrer and a nitrogen introducing tube to conduct a reaction at 230° C. at normal pressure for 8 hours followed by another reaction for 5 hours with a reduced pressure of 15 to 15 mmHg. Then, 760 parts of fumaric acid, and 3.5 parts of hydroquinone are the reaction container to conduct reaction at 210° C. under normal pressure for 5 hours followed by reaction under a reduced pressure to obtain [Polyester 3].

| | | |
|---|---|---|
| Adduct of bisphenol A with 2 mole of ethylene oxide | 36 | parts |
| Adduct of bisphenol A with 2 mole of propylene oxide: | 3,782 | parts |
| Terephthalic acid: | 724 | parts |
| Dibutyl tin oxide: | 15 | parts |

[Polyester 3] has a number average molecular weight of 3,760, a weight average molecular weight of 8,240, a glass transition temperature of 66° C., and an acid value of 24 mgKOH/g.

### Polyester 4

The following components are placed in a container equipped with a condenser, a stirrer and a nitrogen introducing tube to conduct a reaction at 230° C. at normal pressure for 8 hours to synthesize [Polyester Resin 4]:

| | | |
|---|---|---|
| Adduct of bisphenol A with 2 mole of ethylene oxide: | 1,625 | parts |
| Adduct of bisphenol A with 2 mole of propylene oxide: | 1,750 | parts |
| Terephthalic acid: | 1,145 | parts |
| Dodecenyl succinic anhydride: | 161 | parts |
| Trimellitic anhydride: | 480 | parts |
| Dibutyl tin oxide: | 15 | parts |

[Polyester 4] has a number average molecular weight of 3,394, a weight average molecular weight of 7,680, a glass transition temperature of 65° C., and an acid value of 21 mgKOH/g.

### Polyester 5

The following components are placed in a container equipped with a condenser, a stirrer and a nitrogen introducing tube to conduct a reaction at 230° C. at normal pressure for 8 hours followed by another reaction for 8 hours with a reduced pressure of 10 to 15 mmHg and 26 parts by weight of trimellitic anhydride is added to the reaction container to conduct a reaction at 180° C. at normal pressure for 2 hours to obtain [Polyester 5].

| | | |
|---|---|---|
| Adduct of bisphenol A with 2 mole of ethylene oxide | 264 | parts |
| Adduct of bisphenol A with 2 mole of propylene oxide | 523 | parts |
| Terephthalic acid | 123 | parts |
| Adipic acid | 173 | parts |
| Dibutyl tin oxide | 1 | part |

[Polyester 5] has a number average molecular weight of 4,300, a weight average molecular weight of 45,000, a glass transition temperature of 65° C., and an acid value of 12 mgKOH/g.

### Synthesis of Prepolymer

The following components are placed in a container equipped with a condenser, a stirrer and a nitrogen introducing tube to conduct a reaction at 230° C. at normal pressure for 8 hours followed by another reaction for 5 hours with a reduced pressure of 10 to 15 mmHg to synthesize [Intermediate polyester resin 1]:

| | |
|---|---|
| 1,2-propylene glycol | 366 parts |
| Terephthalic acid | 566 parts |
| Trimellitic anhydride | 44 parts |
| Titanium tetrabuthoxide | 6 parts |

[Intermediate Polyester 1] has a number average molecular weight of 3,200, a weight average molecular weight of 12,000, and a glass transition temperature of 55° C.

Next, 420 parts of [Intermediate polyester 1], 80 parts of isophorone diisocyanate and 500 parts of ethyl acetate are placed in a reaction container equipped with a condenser, stirrer and a nitrogen introducing tube to conduct reaction at 100° C. for 5 hours to obtain [Prepolymer]. The obtained [Prepolymer] has an isolated isocyanate in an amount of 1.34% by weight.

### Liquid Dispersion of Polyester Particulate

### Liquid Dispersion 1 of Polyester Particulate

1,500 g of [Polyester 3], 100 g of anionic surface active agent (Neopelex G-15: sodium dodecyl benzene sulfonate: solid portion: 15% by weight, manufactured by Kao Corporation), 15 g of non-ion surface active agent: polyoxyethylene (26 mol) oleyl ether (HLB: 16.2): Emulgen 430, manufactured by Kao Corporation), and 689 g of 5% weight potassium hydroxide aqueous solution are placed in a stainless container and stirred and dispersed at 25 degree C. at 200 r/min by using an oar type stirrer.

The content is stabilized at 95 degree C. and left for 2 hours while being stirred by the oar type stirrer at 200 r/min.

Thereafter, deionized water is dropped to the container at 15 g/min until the amount thereof amounts to 2,845 g while being stirred by the oar type stirrer at 200 r/min.

In addition, the temperature of the system is maintained at 95 degree C. while the deionized water is dropped.

Subsequent to cooling down, the resultant is screened with a metal mesh having 150 meshes (opening: 105 micrometer) to obtain [Liquid dispersion 1 of polyester particulate].

The volume average particle diameter (D50) of the particulates in the obtained [Liquid dispersion 1 of polyester particulate] is 0.15 micrometer and the solid concentration thereof is 31% by weight. No resin component remains on the metal mesh at all.

### Liquid Dispersion 2 of Polyester Particulate

1,500 g of [Polyester 4], 100 g of anionic surface active agent (Neopelex G-15: sodium dodecyl benzene sulfonate: solid portion: 15% by weight, manufactured by Kao Corporation), 15 g of non-ion surface active agent: polyoxyethylene (26 mol) oleyl ether (HLB: 16.2): Emulgen 430, manufactured by Kao Corporation), and 689 g of 5% weight potassium hydroxide aqueous solution are placed in a stainless container and stirred and dispersed at 25 degree C. at 200 r/min by using an oar type stirrer.

The content is stabilized at 95 degree C. and left for 2 hours while being stirred by the oar type stirrer at 200 r/min.

Thereafter, deionized water is dropped to the container at 15 g/min until the amount thereof amounts to 2,845 g while being stirred by the oar type stirrer at 200 r/min.

In addition, the temperature of the system is maintained at 95 degree C. while the deionized water is dropped.

Subsequent to cooling down, the resultant is screened with a metal mesh having 150 meshes (opening: 105 micrometer) to obtain

### [Liquid Dispersion 2 of Polyester Particulate].

The volume average particle diameter (D50) of the particulates in the obtained [Liquid dispersion 2 of polyester particulate] is 0.14 micrometer and the solid concentration thereof is 32% by weight. No resin component remains on the metal mesh at all.

### Liquid Dispersion 3 of Polyester Particulate

1,500 g of [Polyester 2], 100 g of anionic surface active agent (Neopelex G-15: sodium dodecyl benzene sulfonate: solid portion: 15% by weight, manufactured by Kao Corporation), 15 g of non-ion surface active agent: polyoxyethylene (26 mol) oleyl ether (HLB: 16.2): Emulgen 430, manufactured by Kao Corporation), and 689 g of 5% weight potassium hydroxide aqueous solution are placed in a stainless container and stirred and dispersed at 25 degree C. at 200 r/min by using an oar type stirrer. The content is stabilized at 95 degree C. and left for 2 hours while being stirred by the oar type stirrer at 200 r/min. Thereafter, deionized water is dropped to the container at 15 g/min until the amount thereof amounts to 2,845 g while being stirred by the oar type stirrer at 200 r/min. In addition, the temperature of the system is maintained at 95 degree C. while the deionized water is dropped.

Subsequent to cooling down, the resultant is screened with a metal mesh having 150 meshes (opening: 105 micrometer) to obtain [Liquid dispersion 3 of polyester particulate]. The volume average particle diameter (D50) of the particulates in the obtained [Liquid dispersion 2 of polyester particulate]. is 0.14 micrometer and the solid concentration thereof is 32% by weight. No resin component remains on the metal mesh at all.

### Synthesis of Master Batch

40 parts of carbon black (REGUL 400R, manufactured by Cabot Corporation), 60 parts of binder resin (polyester resin) (RS-801, manufactured by Sanyo Chemical Industries, Ltd., Acid value: 10, Mw: 20,000, Tg: 64° C.) and 30 parts of water are mixed by a HENSCHEL MIXER to obtain a mixture in which water sops in a pigment agglomeration body. The mixture is mixed and kneaded for 45 minutes by two rolls where the temperature of the surface is set at 130° C. and pulverized by a pulverizer to the size of 1 mm (D. Thus, [Master batch 1] is obtained.

### Example 1

### Preparation of Oil Phase

24 parts of [Polyester 1], 8 parts of paraffin wax (melting point: 72° C.), and 96 parts of ethyl acetate are placed in a reaction container equipped with a stirrer and a thermometer. After the system is heated to 80° C. while stirring, the system is maintained at 80° C. for 5 hours and then cooled down to 30° C. in one hour. 35 parts of [master batch 1] is admixed for one hour and the mixture is transferred to another vessel to disperse the mixture using a bead mill (ULTRAVISCOMILL from AIMEX) under the following conditions: Liquid feeding speed: 1 kg/hour; Disc rotation perimeter speed: 6 m/sec; Diameter of zirconia beads: 0.5 mm; Filling factor of zirconia beads: 80% by volume; Repeat number of dispersion treatment: 3 times; to obtain [Material solution 1]. Next, 76.5 parts of 70% ethyl acetate solution of [Polyester 1] is added to 81.5 parts of [Material solution 1] followed by a 2 hour stirring with a three one motor to obtain [Oil phase 1]. Ethyl acetate is added to [Oil phase 1] to adjust the solid portion density to be 50% (measured at 130° C., 30 minutes).

### Preparation of Aqueous Phase

202 parts of deionized water, 6.4 parts of 25% by weight aqueous liquid dispersion of organic resin particulates (a copolymer of styrene—methacrylic acid—butyl acrylate—a sodium salt of sulfate of an adduct of methacrylic acid with ethyleneoxide) for stabilizing dispersion, 38.5 parts of 50% aqueous solution of sodium dodecyldiphenyl etherdisulfonate (EREMINOR MON-7, manufactured by Sanyo Chemical Industries, Ltd.), 48.2 parts of 1% aqueous solution of carboxymethyl cellulose as a viscosity improver, and 26 parts of ethyl acetate are mixed and stirred to obtain milk white liquid. This is determined as [Aqueous phase 1].

### Emulsification Process

0.4 parts of isophorone diamine and 27.1 parts of [Prepolymer] are added to all the quantity of the [Oil phase 1] followed by mixing by TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry 1].

### Process of Shelling

20 parts of [Liquid dispersion 1 of polyester particulate] is dropped to [Core particle slurry 1] in 5 minutes while [Core particle slurry 1]. is stirred at 200 rpm by a 3 in 1 motor. Stirring is kept for the next 30 minutes. Thereafter, a small amount of the slurry is collected in a test tube. The slurry is diluted with water of an amount of 10 times as much as the slurry followed by centrifugal with a centrifugal device. Mother toner particles are settled in the bottom of the test tube. The supernatant solution is clear. [Slurry 1 after shelling] is thus obtained.

### Removal of Solvent

[Emulsified slurry 1] is placed in a container equipped with a stirrer and a thermometer and the solvent is removed at 30° C. for 8 hours to obtain [Slurry dispersion 1].

### Washing and Drying

After 100 parts of [Slurry dispersion 1] is filtered with a reduced pressure;

(I): 100 parts of deionized water is added to the filtered cake and the mixture is mixed by a TK HOMOMIXER at a rotation number of 12,000 rpm for 10 minutes;
(II): 100 parts of deionized water is added to the filtered cake of (I) and the resultant is mixed by a TK HOMOMIXER at a rotation number of 12,000 rpm for 30 minutes while applying ultrasonic vibration thereto, and then filtered under a reduced pressure. This operation is repeated until the electric conductivity of the re-slurry liquid is not greater than 10 μS/cm;
(III): 10% hydrochloric acid is added to the re-slurry liquid of (II) to make pH thereof be 4 followed by 30 minute stirring by a three one motor; and
(IV): 100 parts of deionized water is added to the filtered cake of (III) and the resultant is mixed by a TK HOMOMIXER at a rotation number of 12,000 rpm for 10 minutes followed by filtration. This operation is repeated until the electric conductivity of the re-slurry liquid is not greater than 10 μS/cm. Thus, [Filtered cake 1] is obtained. The remaining [Slurry dispersion 1] is washed in the same manner and admixed as [Filtered cake 1].

[Filtered cake 1] is dried by a circulating drier at 45° C. for 48 hours. The dried cake is sieved using a screen having an opening of 75 μm to obtain [Mother toner 1]. 2 parts of hydrophobic silica having a primary particle diameter of about 30 nm and 1 part of hydrophobic silica having a primary particle diameter of about 10 nm are added to 100 parts of this [Mother toner 1] and mixed by a HENSCEL MIXER to obtain [Development agent 10] of the present invention.

### Example 2

### Preparation of Oil Phase

Next, 61.0 parts of 70% ethyl acetate solution of [Polyester 1] is added to 81.5 parts of [Material solution 1] followed by a 2 hour stirring with a three one motor to obtain [Oil phase 2]. Ethyl acetate is added to [Oil phase 2] to adjust the solid portion density to be 50% (measured at 130° C., 30 minutes).

### Emulsification Process

0.4 parts of isophorone diamine and 23.2 parts of [Prepolymer] are added to all the quantity of the [Oil phase 2] followed by mixing by TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry 2].

### Process of Shelling

60 parts of [Liquid dispersion 2 of polyester particulate] is dropped to [Core particle slurry 1]. in 5 minutes while [Core particle slurry 1]. is stirred at 200 rpm by a 3 in 1 motor. Stirring is kept for the next 30 minutes. Thereafter, a small amount of the slurry is collected in a test tube. The slurry is diluted with water of an amount of 10 times as much as the slurry followed by centrifugal with a centrifugal device. Mother toner particles are settled in the bottom of the test tube. The supernatant solution is clear. The processes thereafter are conducted in the same manner as in Example 1 to obtain [Development agent 2].

### Example 3

### Preparation of Oil Phase

Next, 53.2 parts of 70% ethyl acetate solution of [Polyester 1] is added to 81.5 parts of [Material solution 1] followed by a 2 hour stirring with a three one motor to obtain [Oil phase 3]. Ethyl acetate is added to [Oil phase 3] to adjust the solid portion density to be 50% (measured at 130° C., 30 minutes).

### Emulsification Process

0.4 parts of isophorone diamine and 21.3 parts of [Prepolymer] are added to all the quantity of the [Oil phase 3] followed by mixing by TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry 3].

### Process of Shelling

80 parts of [Liquid dispersion 3 of polyester particulate] is dropped to [Core particle slurry 1]. in 5 minutes while [Core particle slurry 1]. is stirred at 200 rpm by a 3 in 1 motor. Stirring is kept for the next 30 minutes. Thereafter, a small amount of the slurry is collected in a test tube. The slurry is diluted with water of an amount of 10 times as much as the slurry followed by centrifugal with a centrifugal device. Mother toner particles are settled in the bottom of the test tube. The supernatant solution is clear. The processes thereafter are conducted in the same manner as in Example 1 to obtain [Development agent 3].

### Example 4

[Development Agent 4] is obtained in the same manner as in Example 2 except that [Liquid dispersion 1 of polyester particulate] in the process of shelling is changed to [Liquid dispersion 3 of polyester particulate].

### Example 5

### Preparation of Oil Phase

24 parts of [Polyester 1], 8 parts of paraffin wax (melting point: 72° C.), and 96 parts of ethyl acetate are placed in a reaction container equipped with a stirrer and a thermometer. After the system is heated to 80° C. while stirring, the system is maintained at 80° C. for 5 hours and then cooled down to 30° C. in one hour. 35 parts of [master batch 1] is admixed for one hour and the mixture is transferred to another vessel to disperse the mixture using a bead mill (ULTRAVISCOMILL from AIMEX) under the following conditions: Liquid feeding speed: 1 kg/hour; Disc rotation perimeter speed: 6 m/sec; Diameter of zirconia beads: 0.5 mm; Filling factor of zirconia beads: 80% by volume; Repeat number of dispersion treatment: 3 times; to obtain [Material solution 1]. Next, 65 parts of 70% ethyl acetate solution of [Polyester 1], 21.6 parts of [Polyester 5], and 21.5 parts of ethyl acetate are added to 81.5 parts of [Material solution 1] followed by 2 hour stirring with a three one motor to obtain [Oil phase 5]. Ethyl acetate is added to [Oil phase 5] to adjust the solid portion density to be 49% (measured at 130° C., 30 minutes).

### Emulsification Process

0.4 parts of isophorone diamine is added to all the quantity of the [Oil phase 5] followed by mixing by a TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry 5].

The processes thereafter are conducted in the same manner as in Example 1 to obtain [Development agent 5].

### Example 6

### Preparation of Oil Phase

24 parts of [Polyester 1], 8 parts of paraffin wax (melting point: 72° C.), and 96 parts of ethyl acetate are placed in a reaction container equipped with a stirrer and a thermometer. After the system is heated to 80° C. while stirring, the system is maintained at 80° C. for 5 hours and then cooled down to 30° C. in one hour. 35 parts of [master batch 1] is admixed for one hour and the mixture is transferred to another vessel to disperse the mixture using a bead mill (ULTRAVISCOMILL from AIMEX) under the following conditions: Liquid feeding speed: 1 kg/hour; Disc rotation perimeter speed: 6 m/sec; Diameter of zirconia beads: 0.5 mm; Filling factor of zirconia beads: 80% by volume; Repeat number of dispersion treatment: 3 times; to obtain [Material solution 1]. Next, 51.3 parts of 70% ethyl acetate solution of [Polyester 1], 18.5 parts of [Polyester 5], and 21.5 parts of ethyl acetate are added to 81.5 parts of [Material solution 1] followed by 2 hour stirring with a three one motor to obtain [Oil phase 6]. Ethyl acetate is added to [Oil phase 6] to adjust the solid portion density to be 49% (measured at 130° C., 30 minutes).

### Emulsification Process

0.4 parts of isophorone diamine is added to all the quantity of the [Oil phase 6] followed by mixing by a TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry 6]. The processes thereafter are conducted in the same manner as in Example 3 to obtain [Development agent 6].

### Comparative Example 1

### Preparation of Oil Phase

80.4 parts of 70% ethyl acetate solution of [Polyester 1] is added to 81.5 parts of [Material solution 1] followed by a 2 hour stirring with a three one motor to obtain [Oil phase R1]. Ethyl acetate is added to [Oil phase R1] to adjust the solid portion density to be 50% (measured at 130° C., 30 minutes).

### Emulsification Process

0.4 parts of isophorone diamine and 28.0 parts of [Prepolymer] are added to all the quantity of the [Oil phase R1] followed by mixing by TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry R1].

### Process of Shelling

10 parts of [Liquid dispersion 1 of polyester particulate] is dropped to [Core particle slurry R2]. in 5 minutes while [Core particle slurry R2] is stirred at 200 rpm by a 3 in 1 motor. Stirring is kept for the next 30 minutes. Thereafter, a small amount of the slurry is collected in a test tube. The slurry is diluted with water of an amount of 10 times as much as the slurry followed by centrifugal with a centrifugal device. Mother toner particles are settled in the bottom of the test tube. The supernatant solution is clear.

The processes thereafter are conducted in the same manner as in Example 1 to obtain [Development agent R1].

### Comparative Example 2

### Preparation of Oil Phase

Next, 53.2 parts of 70% ethyl acetate solution of [Polyester 1] is added to 81.5 parts of [Material solution 1] followed by a 2 hour stirring with a three one motor to obtain [Oil phase R2]. Ethyl acetate is added to [Oil phase R2] to adjust the solid portion density to be 50% (measured at 130° C., 30 minutes).

### Emulsification Process

0.4 parts of isophorone diamine and 21.3 parts of [Prepolymer] are added to all the quantity of the [Oil phase R2] followed by mixing by TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry R2].

### Process of Shelling

80 parts of [Liquid dispersion 2 of polyester particulate] is dropped to [Core particle slurry R2] in 5 minutes while [Core particle slurry R2] is stirred at 200 rpm by a 3 in 1 motor. Stirring is kept for the next 30 minutes. Thereafter, a small amount of the slurry is collected in a test tube. The slurry is diluted with water of an amount of 10 times as much as the slurry followed by centrifugal with a centrifugal device. Mother toner particles are settled in the bottom of the test tube. The supernatant solution is clear. The processes thereafter are conducted in the same manner as in Example 1 to obtain [Development agent R2].

### Comparative Example 3

After [Core particle slurry 1] is obtained in the same manner as in Example 1, the organic solvent is removed without conducting the process of shelling and [Dispersion slurry R3] is obtained. [Dispersion slurry R3] does not contain an organic solvent.

### Process of Shelling

20 parts of [Liquid dispersion 1 of polyester particulate] is placed in all the quantity of [Dispersion slurry 3] while [Dispersion slurry 3] is stirred at 130 rpm using a 3 in 1 motor. Stirring is kept and the system is gradually heated to 65 degree C. using a water bath and 65 degree C. is kept thereafter. Thereafter, 2 g of 50% aqueous solution of magnesium chloride hexahydrate is added and thereafter 1 g of 2 weight % aqueous solution of sodium hydroxide is slowly dropped to the system. 5 minutes after, a small amount of the resultant is collected and diluted with water. Then, the resultant is put into a test tube and separated by a centrifugal. 2 weight % sodium hydroxide is dropped thereto while continuing turbidity of the supernatant fluid.

This operation is repeated 3 times and after the supernatant fluid is continued to be clear, the water bath is cooled down by stopping heating the system. After the system is cooled down to room temperature, stirring is stopped.

Thus, a liquid dispersion, [Slurry 3 after shelling], of mother toner particles in which polyester particulates cover the core particle is obtained. The processes thereafter are conducted in the same manner as in Example 1 to obtain [Development agent R3].

### Comparative Example 4

### Preparation of Oil Phase

Next, 84.3 parts of 70% ethyl acetate solution of [Polyester 1] is added to 81.5 parts of [Material solution 1] followed by a 2 hour stirring with a three one motor to obtain [Oil phase R4]. Ethyl acetate is added to [Oil phase R4] to adjust the solid portion density to be 50% (measured at 130° C., 30 minutes).

### Emulsification Process

0.4 parts of isophorone diamine and 29.0 parts of [Prepolymer] are added to all the quantity of the [Oil phase R4] followed by mixing by TK HOMOMIXER (manufactured by Tokushu Kika Kogyo Co., Ltd.) at a rotation number of 5,000 rpm for 1 minute. All the quantity of [Aqueous phase 1] is admixed therewith by TK HOMOMIXER (manufactured by Tokushu Kika Kogyo Co., Ltd.) at a rotation number of from 8,000 to 13,000 rpm for 20 minutes to obtain [Core particle slurry R4].

### Removal of Solvent

[Core particle slurry R4] is placed in a container equipped with a stirrer and a thermometer and the solvent is removed at 30° C. for 8 hours to obtain [Slurry dispersion R4]. The processes thereafter are performed in the same manner as in Example 1 to obtain [Development Agent R4].

The physical properties and the evaluation results are shown in Table 1 for each development agent obtained in Examples and Comparative Examples described above.

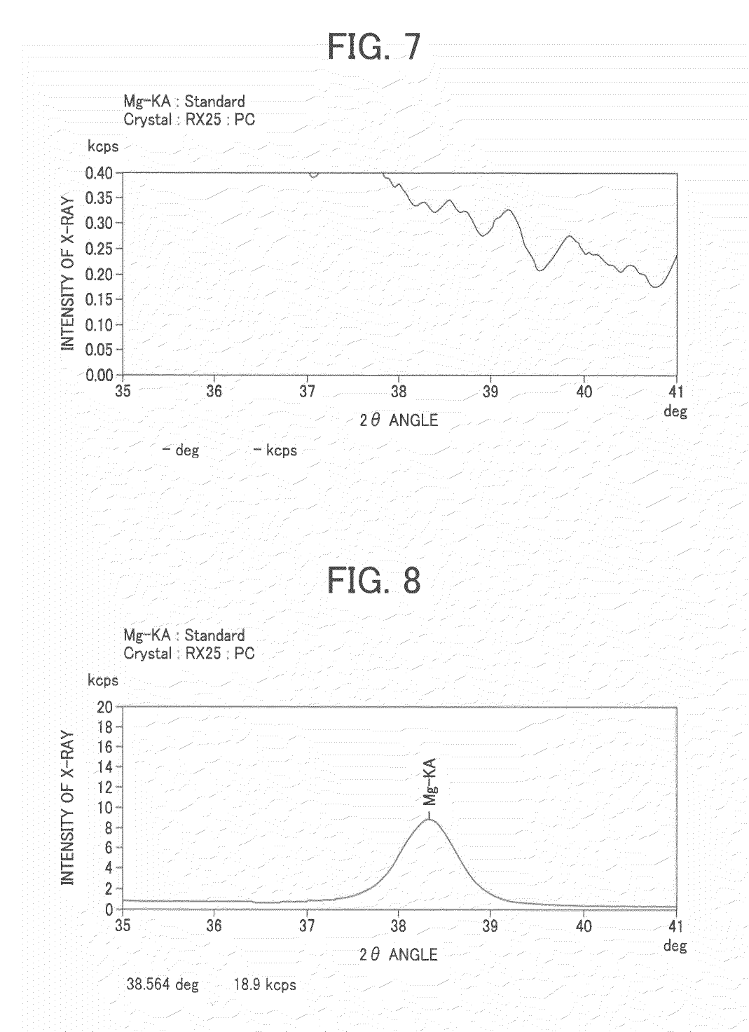

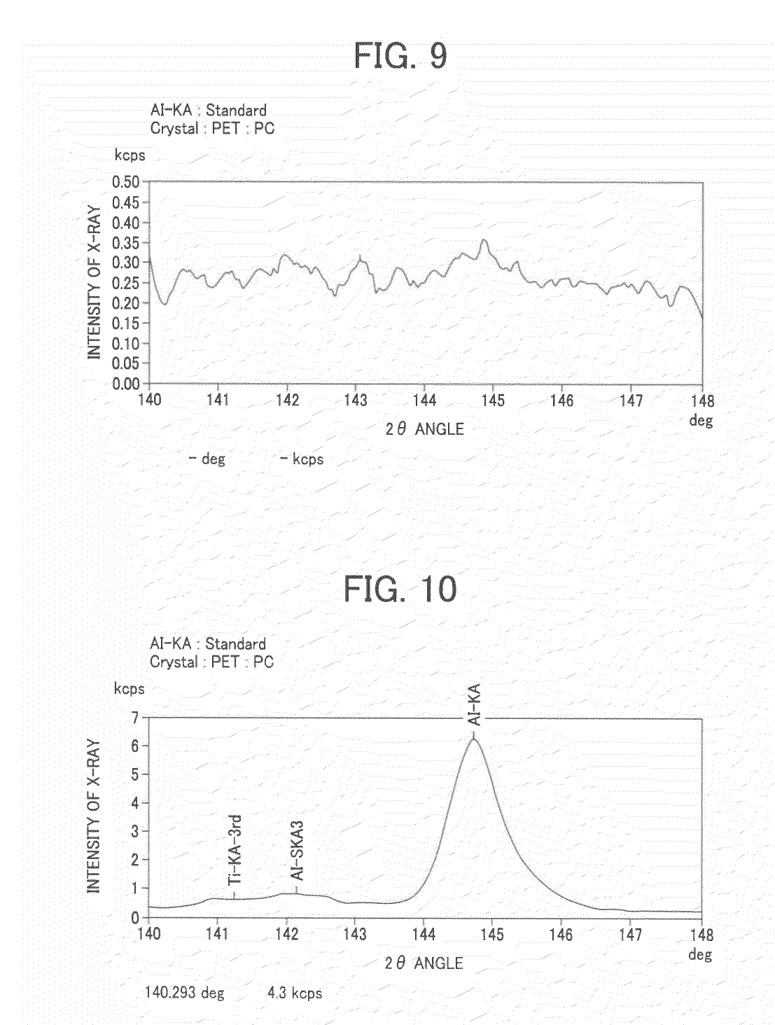

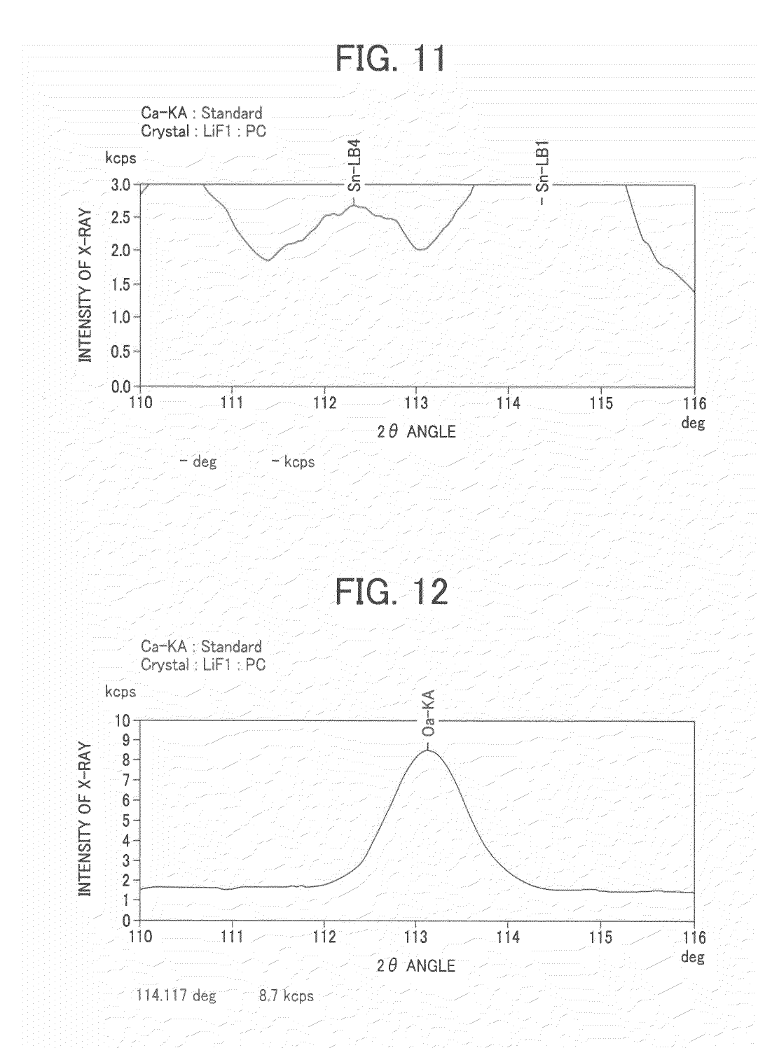

In addition, FIGS. 7, 9 and 11 are graphs illustrating the measuring results of fluorescence X-ray of magnesium, aluminum and calcium of the mother toner particle of Example 1. FIG. 8 is a graph illustrating the measuring results of fluorescence X-ray of the mother toner particle of Comparative Example 3, which contains magnesium. FIG. 10 is a graph illustrating the measuring results of fluorescence X-ray of the mother toner particle which contains aluminum, and FIG. 12 is a graph illustrating the measuring results of fluorescence X-ray of the mother toner particle which contains calcium as reference examples.

TABLE 1

| | Develop- | Toner particle | | | Form | Shell |
|---|---|---|---|---|---|---|
| | ment | diameter | | | Circu- | Average layer |
| | agent | Dv | Dn | Dv/Dn | larity | thickness (nm) |
| Example 1 | 1 | 5.6 | 5.0 | 1.12 | 0.976 | 52 |
| Example 2 | 2 | 5.2 | 4.7 | 1.11 | 0.977 | 103 |
| Example 3 | 3 | 5.5 | 5.0 | 1.10 | 0.977 | 170 |
| Example 4 | 4 | 5.3 | 4.8 | 1.10 | 0.975 | 110 |
| Example 5 | 5 | 5.6 | 5.0 | 1.12 | 0.975 | 60 |
| Example 6 | 6 | 5.4 | 4.8 | 1.13 | 0.973 | 165 |
| Comparative | R1 | 5.5 | 4.9 | 1.12 | 0.973 | 25 |
| Example 1 | | | | | | |
| Comparative | R2 | 5.3 | 4.7 | 1.13 | 0.978 | 220 |
| Example 2 | | | | | | |
| Comparative | R3 | 5.2 | 4.7 | 1.11 | 0.976 | 60 |
| Example 3 | | | | | | |
| Comparative | R4 | 5.2 | 4.7 | 1.11 | 0.972 | — |
| Example 4 | | | | | | |

| | | Evaluation result | | | |
|---|---|---|---|---|---|
| | | Anti- | | | High |
| | Relation- | stress | Environment | Fixing | temperature |
| | ship (1) | Property | Durability | property | preservability |
| Example 1 | G | G | E | E | G |
| Example 2 | G | E | E | G | E |
| Example 3 | G | E | E | G | E |
| Example 4 | G | G | E | E | G |
| Example 5 | G | G | E | G | G |
| Example 6 | G | E | E | G | E |
| Comparative | B | B | B | E | B |
| Example 1 | | | | | |
| Comparative | B | F | F | B | E |
| Example 2 | | | | | |
| Comparative | G | F | F | G | G |
| Example 3 | | | | | |
| Comparative | B | B | B | G | B |
| Example 4 | | | | | |

This document claims priority and contains subject matter related to Japanese Patent Applications No. 2009-064469 and 2010-021049, filed on Mar. 17, 2010, and Feb. 2, 2010, respectively, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
a mother toner particle comprising:
at least two kinds of resins having a polyester skeleton; and
a coloring agent; and
a releasing agent,
wherein the mother toner particle has a core and a shell layer thereon, and no peak that derives from magnesium, calcium, or aluminum in the mother toner particle is observed in a qualitative analysis using an X-ray fluorescence measuring instrument.

2. The toner according to claim 1, wherein the shell layer completely covers the core and has an average thickness of from 1/160 to 1/25 based on a number average particle diameter of the toner.

3. The toner according to claim 2, wherein the average thickness of the shell layer and a glass transition temperature Tg of material of the shell layer satisfy the following relationship:
110−Ts<W<2×(155−Ts),
where Ts represents the glass transition temperature Tg (° C.) of the shell layer and W represents the average thickness (nm) of the shell.

4. The toner according to claim 1, wherein the core comprises a first resin having a first polyester skeleton, and material of the shell layer comprises a second resin having a second polyester skeleton.

5. The toner according to claim 4, wherein the first resin and the second resin are incompatible with each other.

6. The toner according to claim 4, wherein the core further comprises a modified polyester resin having at least one of a urethane group and a urea group.

7. The toner according to claim 6, wherein the modified polyester resin is elongated or cross-linked by reaction between a modified polyester resin having an isocyanate group at an end thereof and an amine.

8. The toner according to claim 1, wherein the releasing agent is paraffin wax, Fischer-Tropsch wax, or polyethylene wax.

9. A development agent comprising:
the toner of claim 1; and
an optional carrier.

10. An image formation method comprising:
charging a surface of an image bearing member uniformly;
writing a latent electrostatic image on the surface of the image bearing member by irradiating the surface of the image bearing member based on image data;
forming a layer of a development agent comprising the toner of claim 1 having a thickness regulated by a layer thickness regulation member on the surface of the image bearing member;
developing the latent electrostatic image with the development agent comprising the toner of claim 1 to obtain a visualized image;
transferring the visualized image on the surface of the image bearing member to a transfer medium; and
fixing the visualized image on the transfer medium.

11. A method of manufacturing a toner comprising:
dissolving or dispersing at least a first resin having a first polyester skeleton, a releasing agent, and a coloring agent in an organic solvent to obtain a lysate or dispersion matter;
forming core particles by suspending the lysate or dispersion matter in an aqueous medium to obtain a liquid suspension in which the core particles are dispersed in the aqueous medium;
preparing a liquid dispersion of particulates comprising a second resin having a second polyester skeleton;
forming a shell layer on the core particles by adding the liquid dispersion of particulates comprising a second resin having a second polyester skeleton to the liquid suspension; and
removing the organic solvent.

12. The method of manufacturing a toner according to claim 11, wherein, in the step of forming a shell layer, the second resin is dissolved in an organic solvent and precipitates on a surface of the core particles to make the shell layer have a successive structure.

13. The method of manufacturing a toner according to claim 11, wherein the aqueous medium comprises a surface active agent.

14. The method of manufacturing a toner according to claim 11, wherein the step of removing the organic solvent is conducted before the step of forming a shell layer.

15. The method of manufacturing a toner according to claim 11, wherein the particulate formed of the second resin has a volume average particle diameter of 0.2 μm or smaller.

16. The method of manufacturing a toner according to claim 11, wherein the step of removing the organic solvent is conducted after the step of forming a shell layer on the core particles.

17. The method of manufacturing a toner according to claim 11, wherein, in the step of forming the shell layer, the shell layer is formed with heating the liquid suspension to a glass transition temperature Tg of the second resin at highest.
